(19) United States
(12) Patent Application Publication
(10) Pub. No.: US 2023/0273334 A1
(43) Pub. Date: Aug. 31, 2023

(54) LONG-OFFSET ACQUISITION WITH TOWED STREAMER SPREADS

(71) Applicants: John CRAMER, Houston, TX (US); PGS Geophysical AS, Oslo (NO)

(72) Inventors: John CRAMER, Houston, TX (US); Neil PADDY, Houston, TX (US); Manuel BEITZ, Oslo (NO)

(21) Appl. No.: 18/016,216

(22) PCT Filed: Jul. 16, 2021
(86) PCT No.: PCT/US2021/041957

§ 371 Date: Jan. 13, 2023

Related U.S. Application Data
(60) Provisional application No. 63/052,765, filed on Jul. 16, 2020.

(51) Int. Cl. G01V 1/38; G01V 1/28; G01V 1/34

(52) U.S. Cl. CPC G01V 1/3843; G01V 1/282; G01V 1/345

(57) ABSTRACT

A method and apparatus for operating a single source vessel along a survey path, the source vessel towing a source and a first plurality of streamers; operating a streamer vessel along the survey path, the streamer vessel towing a second plurality of streamers; actuating the source; acquiring near-offset data with a first plurality of receivers; and acquiring long-offset data with a second plurality of receivers. A system includes a source vessel coupled to: a source; and a near-offset survey spread; a streamer vessel coupled to a long-offset survey spread, wherein a streamer spacing density of the long-offset survey spread is no greater than a streamer spacing density of the near-offset survey spread; and a survey plan including navigation information for the source vessel and the streamer vessel, wherein the navigation information directs the source vessel and the streamer vessel along a common survey path while the source is actuated.

### CROSS REFERENCE TO RELATED APPLICATIONS

This application claims benefit of U.S. Provisional Patent Application Ser. No. 63/052,765, filed Jul. 16, 2020, entitled “Extended Long-Tail Acquisition,” which is incorporated herein by reference.

### BACKGROUND

This disclosure is related generally to the field of marine surveying. Marine surveying can include, for example, seismic and/or electromagnetic surveying, among others. For example, this disclosure may have applications in marine surveying in which one or more sources are used to generate energy (e.g., wavefields, pulses, signals), and geophysical sensors—either towed or ocean bottom—receive energy generated by the sources and possibly affected by interaction with subsurface formations. Geophysical sensors may be towed on cables referred to as streamers. Some marine surveys locate geophysical sensors on ocean bottom cables or nodes in addition to, or instead of, streamers. The geophysical sensors thereby collect survey data (e.g., seismic data, electromagnetic data) which can be useful in the discovery and/or extraction of hydrocarbons from subsurface formations.

Typically, seismic data acquisition using towed streamers is subject to operational limitations related to the maximum receiver offset. Conventionally, maximum offsets are limited by the maximum towing length of the streamers (e.g., about 10 km for multi-streamer configurations; about 12 km for single-streamer configurations). Longer streamers typically require additional towing power, which may be unavailable for the number of streamers in a streamer spread. Even with advanced streamer geometries, such as utilizing a single long-offset streamer (e.g., “rat's tail” configuration) with a near-offset streamer spread, maximum offsets are still limited by a maximum streamer length. For example, longer streamers are subject to higher tensions and higher risk of breaking or separating.

Accurate data processing utilizes accurate knowledge of the position of receivers during data acquisition. However, streamer geometries utilized to gather long-offset data, such as a single long-offset streamer, may suffer from inaccurate positioning information. For example, cross currents, waves, wind, etc., may significantly shift the position of aft-ward portions of long-offset streamers.

Other means of acquiring long-offset data may include utilizing receivers on ocean bottom nodes, utilizing an additional source vessel, and/or survey plans requiring multiple shooting of the same survey area. Each of these alternatives may increase the number of seismic shots utilized to acquire data, thereby increasing environmental risk (e.g., increased high-decibel exposures). For example, increasing the number of sources can result in difficulties when trying to obtain operation permits in environmentally sensitive areas, since certain countries (e.g. Brazil) disallow simultaneous sources due to perceived impacts to marine biota.

It would be beneficial to acquire long-offset data with accurate receiver-positioning information while managing risks associated with long streamers and/or seismic source actuations.

### BRIEF DESCRIPTION OF THE DRAWINGS

So that the manner in which the features of the present disclosure can be understood in detail, a more particular description of the disclosure may be had by reference to embodiments, some of which are illustrated in the appended drawings. It is to be noted, however, that the appended drawings illustrate only exemplary embodiments and are therefore not to be considered limiting of its scope, which may apply to other equally effective embodiments.

FIG. 1A illustrates a marine geophysical survey system. FIG. 1B illustrates another marine geophysical survey system. FIG. 1C illustrates another marine geophysical survey system. FIG. 1D illustrates a source vessel conducting a marine survey according to a “race-track” survey design.

FIG. 2A illustrates an exemplary Extended Long-Tail (ELT) survey system. FIG. 2B illustrates an exemplary streamer vessel towing a streamer spread.

FIG. 3 illustrates a graph of the Nyquist relation of aliased frequencies and spatial sampling.

FIG. 4A illustrates another exemplary ELT survey system. FIG. 4B illustrates an exemplary CMP distribution corresponding to the ELT survey system of FIG. 4A. FIG. 4C illustrates an exemplary towing lead-in configuration for the long-offset streamer spread of the ELT survey system of FIG. 4A. FIG. 4D illustrates another view of the exemplary ELT survey system of FIG. 4A.

FIG. 5A illustrates another exemplary ELT survey system. FIG. 5B illustrates an exemplary CMP distribution corresponding to the ELT survey system of FIG. 5A.

FIG. 6A illustrates another exemplary ELT survey system. FIG. 6B illustrates an exemplary CMP distribution corresponding to the ELT survey system of FIG. 6A. FIG. 6C illustrates an exemplary towing lead-in configuration for the long-offset streamer spread of the ELT survey system of FIG. 6A. FIG. 6D illustrates another view of the exemplary ELT survey system of FIG. 6A.

FIG. 7A illustrates another exemplary ELT survey system. FIG. 7B illustrates an exemplary CMP distribution corresponding to the ELT survey system of FIG. 7A. FIG. 7C illustrates an exemplary towing lead-in configuration for the long-offset streamer spread of the ELT survey system of FIG. 7A. FIG. 7D illustrates another view of the exemplary ELT survey system of FIG. 7A.

FIG. 8 illustrates another exemplary ELT survey system.

FIG. 9 illustrates an exemplary system for a surveying method with ELT survey systems.

FIG. 10 illustrates an exemplary machine for an ELT surveying method.

### DETAILED DESCRIPTION

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about +−10% variation. The term “nominal” means as planned or designed in the absence of variables such as wind, waves, currents, or other unplanned phenomena. “Nominal” may be implied as commonly used in the field of marine surveying.

As used herein, the term “axial” or “axial direction” shall mean, for an object or system having a canonical axis, a direction along a proximal portion of the axis.

As used herein, the term “lateral” or “lateral direction” shall mean, for an object or system having a canonical axis, a direction perpendicular to a proximal portion of the axis. Often, in relation to towed streamers, “lateral direction” is understood to be at a fixed depth.

As used herein, the term “offset” of a source-receiver pair means the nominal lateral (i.e., perpendicular to depth) distance between the source and the receiver. As used herein, the term “near offset” will generally refer to offsets less than about 12 km, such as about 5 km to about 10 km. As used herein, the term “long offset” will generally refer to offsets greater than about 12 km, such as about 12 km to about 20 km. As used herein, the term “ultra-long offset” will generally refer to particular long offsets that are at least about 20 km, such as about 20 km to about 50 km.

As used herein, the term “inline” or “inline direction” shall mean, for equipment towed by a vessel, a direction along (or parallel to) the path traversed by the vessel.

As used herein, the term “crossline” or “crossline direction” shall mean, for equipment towed by a vessel, a fixed-depth direction perpendicular to the path traversed by the vessel.

As used herein, the terms “narrow azimuth” and “wide azimuth” should be interpreted in light of common industry usage. For example, “narrow azimuth” tends to reflect survey configurations capable of acquiring data at azimuth angles of less than about 20° at most of the applicable offsets. “Wide azimuth” tends to reflect survey configurations capable of acquiring data at azimuth angles of greater than about 20° at most of the applicable offsets. Typically, narrow-azimuth surveys utilize a source that is central to a distribution of streamers, for example, a midline source with streamers symmetrically distributed about the midline. Typically, wide-azimuth surveys utilize a source that is external to a distribution of streamers, for example, a source vessel traversing a path that is offset from the towing path of the streamers.

As used herein, the terms “cable” or “line” shall mean a flexible, axial load carrying member that may or may not include electrical and/or optical conductors for carrying electrical power and/or signals between components. Such a line may be made from fiber, steel, other high strength material, chain, or combinations of such materials.

“Lead-in line” shall mean a line that couples (e.g., axial load, data, and/or power) a survey vessel to a streamer or streamer spread. Often, lead-in lines are selected, designed, and/or manufactured to meet operational conditions. For example, the axial strength of a lead-in line will impact the acceptable drag from the streamer spread and the acceptable towing velocities and/or accelerations. Additionally, lead-in lines may be designed to provide a high signal and/or power carrying capacity while having a small outer diameter. Unlike streamers, lead-in lines do not include receivers for measuring geophysical (e.g., seismic, electromagnetic) signals.

As used herein, the terms “signal source,” “source,” or “source element” refer to an apparatus (or array of apparatuses) that is configured to emit a signal (e.g., acoustic, electromagnetic, etc.) that may be reflected from one or more subsurface structures and then detected and/or measured.

As used herein, the phrase “source separation” refers to the nominal crossline distance between adjacent sources.

As used herein, the term “streamer” shall mean an apparatus (e.g., a cable) that may be towed behind a survey vessel (e.g., a source vessel or a streamer vessel) to detect and/or measure geophysical signals (e.g., seismic signals, electromagnetic signals). A streamer may include detectors, sensors, receivers, and/or other structures (e.g., hydrophones, geophones, electrodes) positioned along or within the streamer and configured to detect and/or measure the geophysical signals. Streamers may be towed in arrays, distributed in at least the crossline direction, and referred to collectively as a “spread” or a “streamer spread.”

As used herein, the phrase “streamer separation” refers to the nominal crossline distance between adjacent streamers.

As used herein, the phrase “acoustic bracing” or simply “bracing” refers to determining relative positions of, and/or distances between, elements of a marine survey system by measuring the traveltime between transducers (also known as “acoustic generators” or “pingers”) and detectors located at the different elements. For example, the actual (rather than nominal) streamer separation may be determined with pingers and/or detectors located in the streamers (e.g., at the forward section, mid section, and/or aft section of the streamers) when more than one streamer is being towed (e.g., in a streamer spread). The combination of acoustic generators and detectors may be referred to as an “acoustic bracing network.”

As used herein, the term “midline” refers to a centerline of a survey vessel, extending inline behind the survey vessel to the farthest element of the survey (e.g., the aft of a streamer spread). Typically, for towing efficiency, the sources and/or the streamer spread will be centered on the midline.

As used herein, the term “source vessel” shall mean a watercraft, manned or unmanned, that is configured to carry and/or tow, and in practice does carry and/or tow, one or more geophysical sources. Source vessels may or may not carry or tow one or more geophysical streamers.

As used herein, the term “streamer vessel” shall mean a watercraft, manned or unmanned, that is configured to tow, and in practice does carry and/or tow, one or more geophysical streamers. Unless otherwise specified, streamer vessels should be understood to not carry or tow one or more geophysical sources.

As used herein, the term “survey vessel” shall mean a watercraft, manned or unmanned, that is configured to tow, and in practice does carry and/or tow, one or more geophysical sources and/or one or more geophysical streamers.

As used herein, the term “forward” or “front” shall mean the direction or end of an object or system that corresponds to the intended primary direction of travel of the object or system.

As used herein, the terms “aft” or “back” shall mean the direction or end of an object or system that corresponds to the reverse of the intended primary direction of travel of the object or system.

As used herein, the terms “port” and “starboard” shall mean the left and right, respectively, direction or end of an object or system when facing in the intended primary direction of travel of the object or system.

As used herein, the term “survey data” shall mean data utilized by and/or acquired during a survey, including detected signals, seismic data, electromagnetic data, pressure data, particle motion data, particle velocity data, particle acceleration data, clock data, position data, depth data, speed data, temperature data, etc.

As used herein, the term “obtaining” data or information shall mean any method or combination of methods of acquiring, collecting, synthesizing, designing, or accessing data or information, including, for example, directly measuring or sensing a physical property, receiving transmitted data, selecting data from a group of physical sensors, identifying data in a data record, generating data or information manually and/or programmatically, and retrieving data or information from one or more data libraries.

As used herein, the term “simultaneous” does not necessarily mean that two or more events occur at precisely the same time or over exactly the same time period. Rather, as used herein, “simultaneous” means that the two or more events occur near in time or during overlapping time periods. For example, the two or more events may be separated by a short time interval that is small compared to the duration of the surveying operation. As another example, the two or more events may occur during time periods that overlap by about 40% to about 100% of either period.

If there is any conflict in the usages of a word or term in this specification and one or more patent or other documents that may be incorporated herein by reference, the definitions that are consistent with this specification should be adopted for the purposes of understanding this disclosure.

The present disclosure generally relates to marine seismic/electromagnetic survey methods and apparatuses, and, at least in some embodiments, to novel source and streamer configurations, and their associated methods of use.

One of the many potential advantages of the embodiments of the present disclosure, is that high-frequency seismic data may be acquired using relatively dense streamer spacing while low-frequency seismic data is acquired using relatively sparse streamer spacing. For example, high-frequency seismic data may be acquired using a first streamer spread, low-frequency seismic data may be acquired using a second streamer spread, and the streamer spacing density of the first streamer spread may be greater than or equal to the streamer spacing density of the second streamer spread. Such relatively dense streamer spacing allows for a crossline sampling density that is sufficient for imaging with high frequencies. At longer offsets, the maximum frequencies are reduced due to earth attenuation. Thus, long-offset data may be applicable to methods utilizing low-frequency seismic data, such as velocity model building, which has less stringent crossline sampling density requirements.

Data having long offsets are useful for velocity model building, while such long-offset data are often discarded in imaging. Particularly Full Waveform Inversion and related methods (generally referred to as “FWI methods”) benefit from long-offset data by modelling refracted energy and fitting it to long-offsets data. FWI methods typically utilize a great deal of computer resources. Consequently, FWI methods may attempt to limit input data to low frequencies to reduce computing costs.

FWI methods can significantly improve the quality of a final image by giving indications about the velocity structure of the subsurface. For example, FWI methods may utilize ultra-long offsets to update diving waves in pre-salt regions of the subsurface. FWI methods can be used to stabilize the velocity model building process. The resulting improved velocity model may then allow for better final images, even if only near-offset data are utilized with the velocity model for imaging procedures. Therefore, valuable data may be acquired at long offsets, even when imaging procedures are the focus.

Another potential advantage includes survey systems in which longer offsets may be achieved by utilizing a single source vessel. For example, embodiments disclosed herein may utilize an additional streamer vessel, rather than the more conventional additional source vessel. For example, a second streamer spread may be deployed from a second streamer-only vessel, generally preceding or following inline to the first streamer spread. Data acquired by this second streamer spread may be used, for example, for velocity model building through FWI methods.

Another potential advantage includes utilizing refraction data (e.g., for FWI) at long offsets. Generally, near-offset data represents seismic reflections from targets in the subsurface formation. At longer offsets, such reflections may attenuate. However, seismic refractions may travel along interfaces in the subsurface, thereby being detectable in long-offset data. In other words, embodiments disclosed herein may provide near-offset data that includes reflection data, and long-offset data includes refraction data. It is currently believed that the formation depth at which refracted information can be recorded (and, consequently, the formation depth at which a target may be identified in the refraction data) is approximately about ⅓ to about ½ of the offset. For example, refraction data at an offset of about 12 km may be used to identify a target at a formation depth of about 4 km to about 6 km.

At least one embodiment of the present disclosure may utilize sparse crossline sampling density for the long-offset data. FWI methods typically utilize input data with much lower frequency ranges than input data used for imaging, thereby allowing for significant relaxation of spatial sampling of long-offset data during acquisition. As a result, it is possible to tow long-offset streamers at a larger spacing, thus reducing operational effort and overall cost. For example, the second streamer spread may be towed by a smaller, more cost efficient survey vessel. As another example, the second streamer spread may consist of hydrophone-only streamers to further reduce cost.

At least one embodiment of the present disclosure may allow acquisition of ultra-long-offset data with only a single source vessel. For example, ultra-long-offset data may be acquired in areas where additional sources and/or source vehicles are not an option due to regulators or environmental concerns.

Additionally, at least one embodiment of the present disclosure may allow acquisition of long-offset data in a multi-azimuth mode.

Embodiments of the present disclosure can thereby be useful in the discovery and/or extraction of hydrocarbons from subsurface formations.

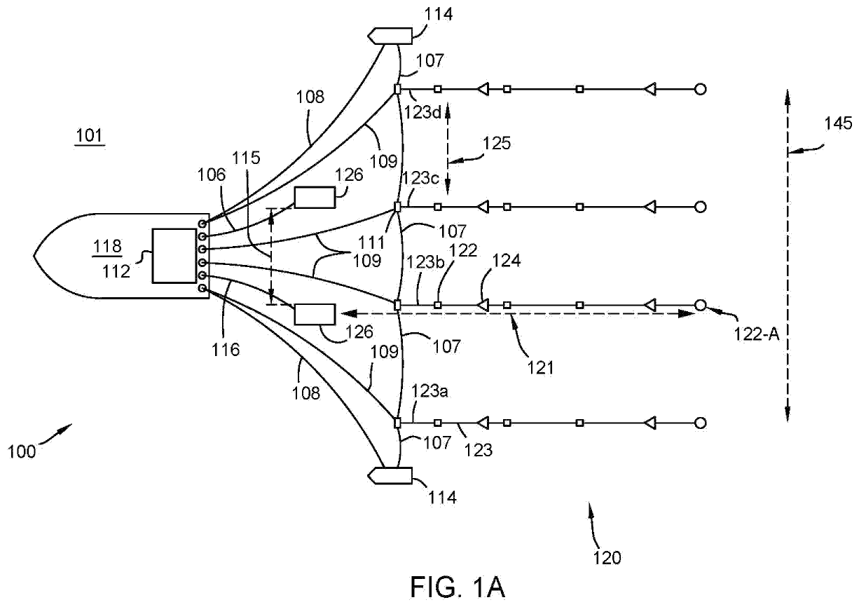

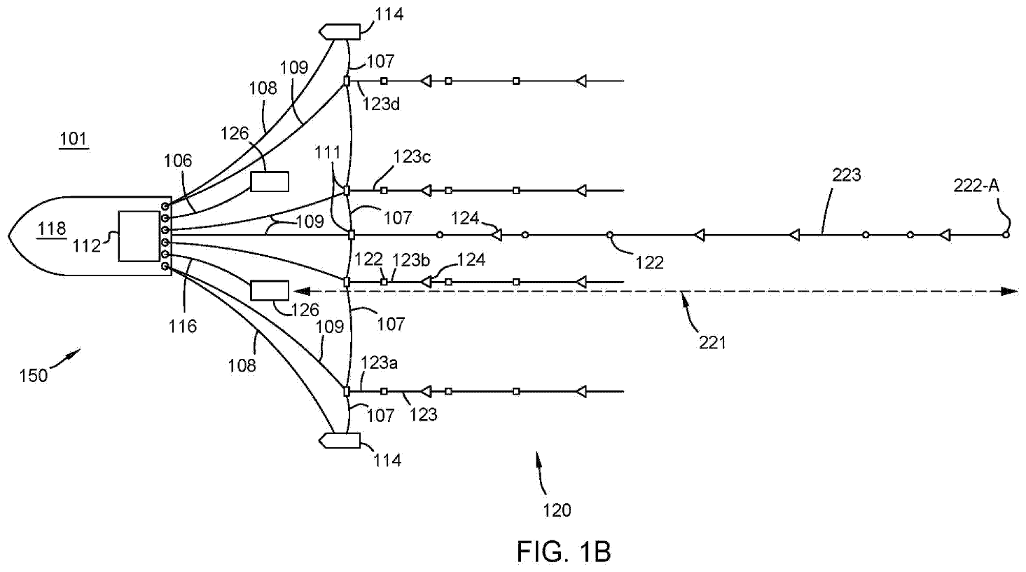

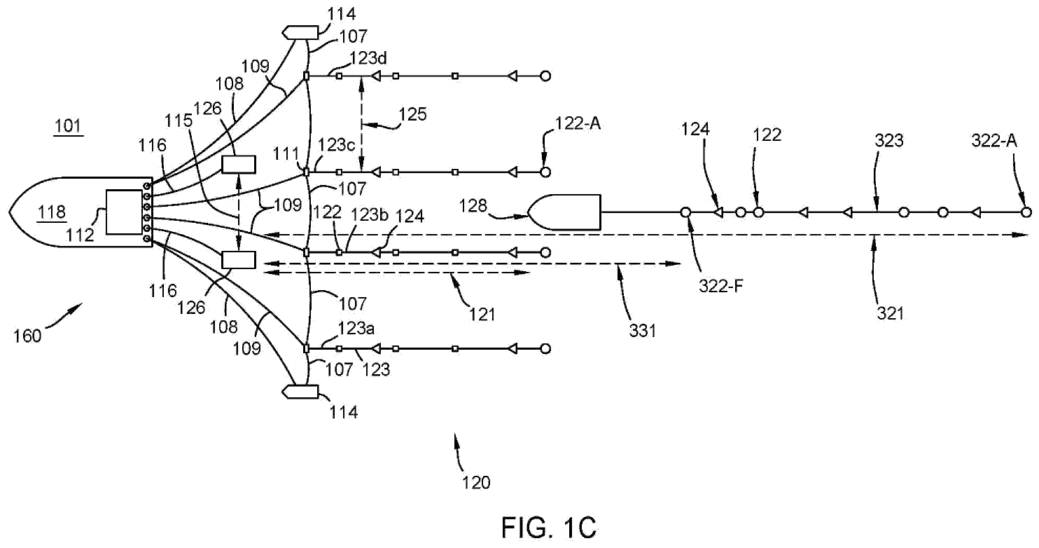

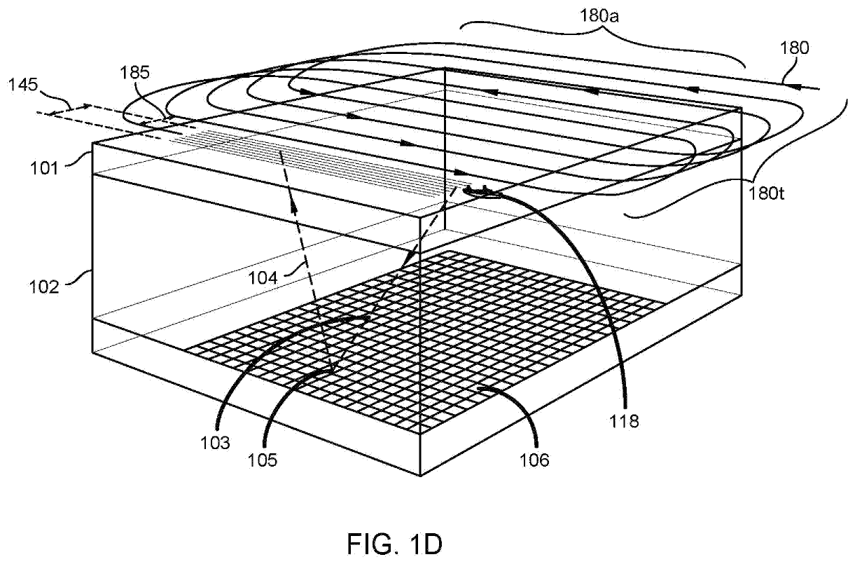

FIG. 1A illustrates a marine geophysical survey system 100. System 100 includes source vessel 118 that may be configured to move along a surface of body of water 101 (e.g., an ocean or a lake). In FIG. 1A, source vessel 118 tows signal sources 126 and near-offset streamers 123. The near-offset streamers 123 may be of conventional length. For example, the length of each near-offset streamer 123 may be about 5 km to about 12 km.

Signal sources 126 are shown in FIG. 1A being towed by source vessel 118 using source cables 116. Each of signal sources 126 may include sub-arrays of multiple individual signal sources. For example, signal source 126 may include a plurality of seismic sources, such as air guns or marine vibrators, and/or electromagnetic signal sources. As illustrated, the two signal sources 126 are distributed about a midline of source vessel 118 and distanced from one another by a nominal crossline source separation 115, which may be greater than, equal to, or less than nominal crossline streamer separation 125. The signal sources 126 may be independently activated, activated simultaneously, activated in a sequential pattern, and/or activated randomly with respect to one another. In some embodiments (not shown), signal sources 126 may be distributed asymmetrically with respect to the midline of source vessel 118.

Near-offset streamers 123 may include a variety of receivers 122. Receivers 122 may include seismic receivers or sensors, such as hydrophones, pressure sensors, geophones, particle motion sensors, and/or accelerometers. Receivers 122 may include electromagnetic sensors, such as electrodes or magnetometers. Receivers 122 may include any suitable combination of these and/or other types of geophysical sensors. Near-offset streamers 123 may further include streamer steering devices 124 (also referred to as “birds”) which may provide controlled lateral and/or vertical forces to near-offset streamers 123 as they are towed through the water, typically based on wings or hydrofoils that provide hydrodynamic lift. Near-offset streamers 123 may further include tail buoys (not shown) at their respective back ends. The number and distribution of receivers 122, streamer steering devices 124, and tail buoys along each near-offset streamer 123 may be selected in accordance with manufacturing and operational circumstances or preferences.

As illustrated in FIG. 1A, near-offset streamers 123 are coupled to source vessel 118 via lead-in lines 109 and lead-in terminations 111. Lead-in lines 109 may generally be about 750 m to about 1500 m, or more specifically about 1000 m to about 1200 m in total length. Typically, about half of the total length of lead-in line 109 will be in the water. For example, about 400 m to about 500 m of lead-in line 109 may be in the water during operation. Lead-in terminations 111 may be coupled to or associated with spreader lines 107 so as to nominally fix the lateral positions of near-offset streamers 123 with respect to each other and with respect to a centerline of source vessel 118. Near-offset streamers 123a-123d may be nominally fixed in lateral positions with respect to each other in order to form a near-offset streamer spread 120 to collect geophysical survey data as source vessel 118 traverses the surface of body of water 101. In a near-offset streamer spread 120, the streamer separation 125 may range from about 25 m to about 200 m. As shown, system 100 may also include two paravanes 114 coupled to source vessel 118 via paravane tow lines 108. Paravanes 114 may be used to provide a streamer separation force for near-offset streamer spread 120. As illustrated, source vessel 118, near-offset streamer spread 120, and signal sources 126 represent a narrow-azimuth (NAZ) survey configuration, with the signal sources 126 being closer to the midline than either the port-most or starboard-most streamer 123. The streamers 123 may include positioning equipment, such as acoustic transducers and/or detectors, that can be used to determine actual and/or relative positioning of the streamers 123 (e.g., via acoustic bracing).

In various embodiments, a geophysical survey system may include any appropriate number of towed signal sources 126 and near-offset streamers 123. For example, FIG. 1A shows two signal sources 126 and four near-offset streamers 123. Other embodiments may include one to eight (or more) signal sources 126. It should be appreciated that near-offset streamer spreads 120 commonly include as few as two and as many as twenty-four or more near-offset streamers 123. In one embodiment, for example, source vessel 118 may tow eighteen or more near-offset streamers 123. A geophysical survey system with an increased number of signal sources 126 and/or near-offset streamers 123 may allow for more survey data to be collected and/or a wider near-offset streamer spread 120 to be achieved. The width of a streamer spread may be determined by the streamer separation 125 and the number of streamers in the streamer spread. For example, near-offset streamer spread 120 may have a spread width 145 of about 300 m to about 3 km.

Geodetic position (or “position”) of the various elements of system 100 may be determined using various devices, including navigation equipment such as relative acoustic ranging units and/or global navigation satellite systems (e.g., a global positioning system (GPS)).

Source vessel 118 may include equipment, shown generally at 112 and for convenience collectively referred to as a “recording system.” Recording system 112 may include devices such as a data recording unit (not shown separately) for making a record (e.g., with respect to time) of signals collected by various geophysical sensors. For example, in various embodiments, recording system 112 may be configured to record reflected signals detected or measured by receivers 122 while source vessel 118 traverses the surface of body of water 101. Recording system 112 may also include a controller and/or navigation equipment (not shown separately), which may be configured to control, determine, and record, at selected times, the geodetic positions of: source vessel 118, signal sources 126, near-offset streamers 123, receivers 122, etc. Recording system 112 may also include a communication system for communicating between the various elements of system 100, with other vessels, with on-shore facilities, etc.

As illustrated, system 100 has aft-most receivers 122-A. For example, each aft-most receiver 122-A may be at or near the aft-most end of a near-offset streamer 123. In the illustrated embodiment, aft-most receiver 122-A is aft of each illustrated streamer steering device 124, but other configurations are possible. The lateral distance between signal source 126 and aft-most receiver 122-A is the maximum offset 121 of system 100. Typically, marine geophysical survey systems, such as systems 100, have maximum offsets 121 in the near-offset range.

FIG. 1B illustrates another marine geophysical survey system 150. As illustrated, system 150 is configured for single-streamer long-offset acquisition. In many aspects, system 150 is configured similarly to system 100. However, system 150 includes a single long-offset streamer 223 (e.g., “rat's tail” configuration). For example, the length of each near-offset streamer 123 may be about 5 km to about 12 km, while the length of single long-offset streamer 223 may be about 12 km to about 40 km. As illustrated, single long-offset streamer 223 is coupled to source vessel 118 via a lead-in line 109 and a lead-in termination 111. In some embodiments, the lead-in termination 111 of single long-offset streamer 223 may be coupled to or associated with spreader lines 107 so as to nominally fix the lateral positions of single long-offset streamers 223 with respect to near-offset streamers 123. As with near-offset streamers 123, single long-offset streamer 223 may include receivers 122, streamer steering devices 124, and tail buoys. The number and distribution of receivers 122, streamer steering devices 124, and tail buoys along single long-offset streamer 223 may be selected in accordance with manufacturing and operational circumstances or preferences. In some embodiments, receivers 122 on single long-offset streamer 223 may be low-frequency seismic receivers configured to detect and/or measure low-frequency seismic signals (e.g., about 1 Hz to about 30 Hz, or about 1 Hz to about 7 Hz). In some embodiments, system 150 may have an aft-most receiver 222-A providing a maximum offset 221 of about 12 km to about 40 km.

As would be appreciated by one of ordinary skill in the art with the benefit of this disclosure, long streamer cables (e.g., longer than about 12 km) can pose several challenges. For example, the axial strength of a standard streamer cable may not be sufficient to withstand the towing forces incurred by a long streamer cable. As another example, increasing the length of streamer cables may increase drag, and thereby increase operational costs. A s another example, the capacity of data buses in a standard streamer cable may not be sufficient for the data expected from a long streamer cable. For example, a long streamer cable may have many more receivers than a standard streamer cable, each acquiring data to be carried by the data buses. As another example, data signals along data buses in long streamer cables may require repeaters to boost the signal along the length of the long streamer cable. As another example, the capacity of power lines and/or power sources in a standard streamer cable may not be sufficient for the power demands expected from a long streamer cable. Moreover, low-frequency/long-offset data may be less useful for conventional imaging, especially 3D imaging, compared to high-frequency data.

FIG. 1C illustrates another marine geophysical survey system 160. As illustrated, system 160 is configured for single-streamer long-offset acquisition. In many aspects, system 160 is configured similarly to system 150. However, system 160 includes a single long-offset streamer 323 towed by long-offset streamer vessel 128. For example, the length of each near-offset streamer 120 may be about 5 km to about 12 km, while the length of single long-offset streamer 323 may be about 5 km to about 50 km. As illustrated, single long-offset streamer 323 is coupled to long-offset streamer vessel 128. For example, single long-offset streamer 323 may be coupled to long-offset streamer vessel 128 via a lead-in line (not shown) and a lead-in termination (not shown). As with near-offset streamers 120, single long-offset streamer 323 may include receivers 122, streamer steering devices 124, and/or tail buoys (not shown). The number and distribution of receivers 122, streamer steering devices 124, and/or tail buoys along single long-offset streamer 323 may be selected in accordance with manufacturing and operational circumstances or preferences. In some embodiments, receivers 122 on single long-offset streamer 323 may be low-frequency seismic receivers configured to detect and/or measure low-frequency seismic signals (e.g., about 1 Hz to about 30 Hz, or about 1 Hz to about 7 Hz). In some embodiments, single long-offset streamer 323 may have a forward-most receiver 322-F providing a minimum offset 331 (for the single long-offset streamer 323) of at least about 10 km, for example about 10 km to about 15 km. In some embodiments, single long-offset streamer 323 may have an aft-most receiver 322-A providing a maximum offset 321 in the ultra-long offset range.

In some embodiments, communications equipment may be associated with single long-offset streamer 323 for communicating (e.g., wirelessly) among various elements of single long-offset streamer 323, among various elements of system 160, with other vessels, with on-shore facilities, etc. For example, communications equipment may be included as a component of the long-offset streamer vessel 128, of the tail buoy of single long-offset streamer 323, or of any other component associated with single long-offset streamer 323. The communications equipment may provide data communications between components of system 160, such as between receivers 122 of single long-offset streamer 323 and recording system 112 of source vessel 118. For example, communications equipment may be useful for synchronizing shot times from signal sources 126 with recording times for data acquired by receivers 122 and/or recorded on long-offset streamer vessel 128.

In some embodiments, long-offset streamer vessel 128 may be an unmanned watercraft, such as a remotely-operated vehicle (ROV) and/or a depth control buoy. For example, the long-offset streamer vessel 128 may control the position and/or depth of a portion (e.g., the front end) of single long-offset streamer 323 and/or any lead-in line coupled thereto. In some embodiments, long-offset streamer vessel 128 is coupled to single long-offset streamer 323 by a remotely controlled (e.g. radio-controlled) winch. For example, long-offset streamer vessel 128 and any winch thereon may be managed from an instrument room onboard the source vessel 118. In some embodiments, the long-offset streamer vessel 128 may be configured to communicate with the source vessel 118 to provide remote control of the position and/or depth of the single long-offset streamer 323, and/or remote monitoring of technical information about the long-offset streamer vessel 128, such as humidity and voltage. In some embodiments, the long-offset streamer vessel 128 and any winch thereon may be powered by an onboard power supply, which can include, for example, a battery and a power harvester, such as an underwater generator, that provides power to the battery, to allow the long-offset streamer vessel 128 to be operated without maintenance for several months at the time.

As illustrated in FIG. 1C, system 160 may be configured and/or operated so that single long-offset streamer 323 is towed along a midline of the path of source vessel 118. For example, long-offset streamer vessel 128 may navigate a survey path that nominally follows the survey path of source vessel 118. As another example, any streamer steering devices 124 associated with single long-offset streamer 323 may cause the single long-offset streamer 323 to nominally follow along the midline of the path of source vessel 118.

FIG. 1D illustrates a source vessel 118 conducting a marine survey according to a “race-track” survey design. Source vessel 118 is shown following a path 180. The path 180 includes linear (e.g., nominally straight-line) portions, acquisition paths 180-a (also known as “sail lines”), wherein survey data acquisition may occur. The path 180 also includes curved portions, turn paths 180-t, wherein the source vessel 118 turns between acquisition paths, and wherein survey data acquisition may not occur. Typically, the acquisition paths 180-a would be nominally parallel, and adjacent acquisition paths 180-a would be equally spaced apart throughout the entire survey area. The sail-line separation 185 between adjacent acquisition paths 180-a is related to the spread width 145 and the crossline sampling density of survey data desired. The related parameters may be selected to generate contiguous or “tiled” areas of subsurface illumination. For example, for a survey with a regular streamer spread having N streamers and a uniform nominal sail-line separation:

Sail—line separation=0.5×N×streamer separation (1)

As illustrated, the source vessel 118 travels in one direction on four adjacent acquisition paths 180-a, and in the opposite direction on the next four adjacent acquisition paths 180-a. Each set of adjacent acquisition paths with a common shooting direction is referred to as a “swath”.

As would be understood by one of ordinary skill in the art with the benefit of this disclosure, other applicable survey designs provide acquisition paths 180-a that are not linear for example, circular towing and/or spiral towing. In some instances, such survey designs may minimize the time the source vessel 118 spends not acquiring survey data. For simplicity, the following discussion focuses on straight-line acquisition paths 180-a. Common methods for marine surveying and data processing may be used to adapt the following discussion to non-straight-line procedures.

FIG. 1D also illustrates source vessel 118 traveling through body of water 101 above subsurface formation 102. A seismic source (not shown) towed by source vessel 118 generates energy that follows one exemplary down-going wave route 103 through body of water 101 and into subsurface formation 102. As illustrated, the energy intersects a reflector 105 in the subsurface formation 102, causing the energy to propagate along up-going wave route 104. Reflector 105 may be, for example, an interface between geological structures. Sampling grid 106 is modeled at the depth of reflector 105. Although the subsurface geology is rarely flat, common data processing techniques may model interfaces as flat (uniform depth) for at least a portion of the calculations. Generally, the size of the sampling grid bins is determined based on the desired resolution of the resulting picture of the subsurface formation 102. By considering all possible wave routes from all available seismic source-receiver pairs, the associated seismic trace from each seismic source-receiver pair may be determined. Typically, each bin of sampling grid 106 may contain about sixty traces. A single common midpoint may be determined where the survey data from the receivers may be stacked to maximize the fold. More particularly, the dimensions of each bin are related to the inline receiver separation along the streamers (e.g., about 12.5 m), and the streamer separation (125 in FIG. 1A). The dimensions of each bin are also related to the number of seismic sources being utilized (e.g., single-source setup, dual-source setup, triple-source setup, etc.). For a survey with a regular streamer spread, the crossline bin width (proximal the midline (e.g., no more than about 10% of the spread width 145 away from the midline)) is given by:

$$Crossline bin {width}_{midline} = 0.5 \times \frac{streamer separation}{number of sources} \qquad ( 2 )$$

Smaller bin width (narrower bins) correspond to higher crossline sampling density, and consequently higher resolution of the resulting picture of the subsurface formation 102.

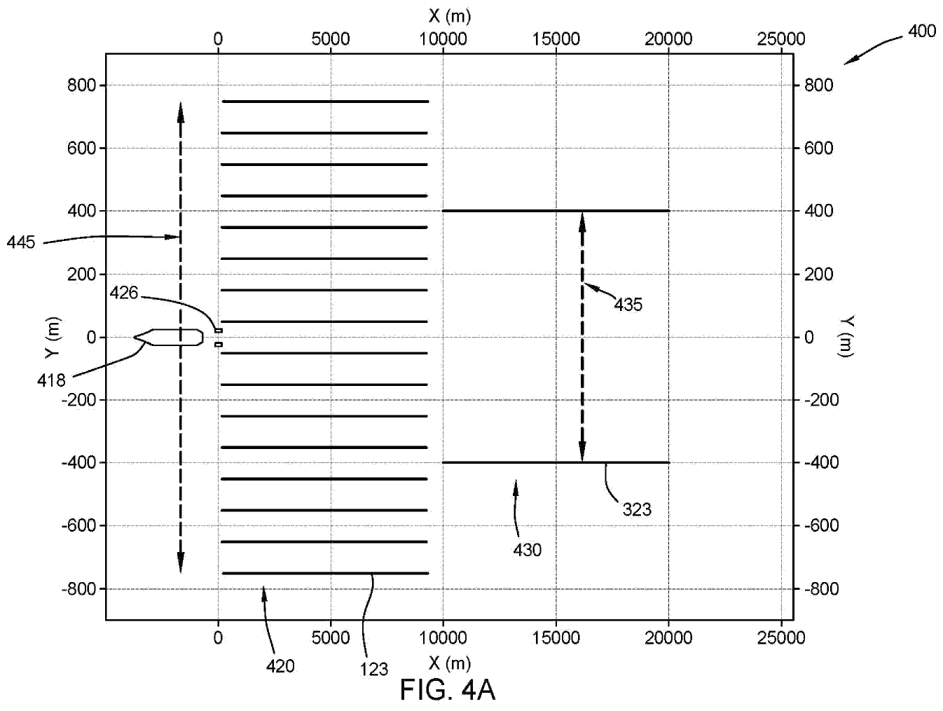

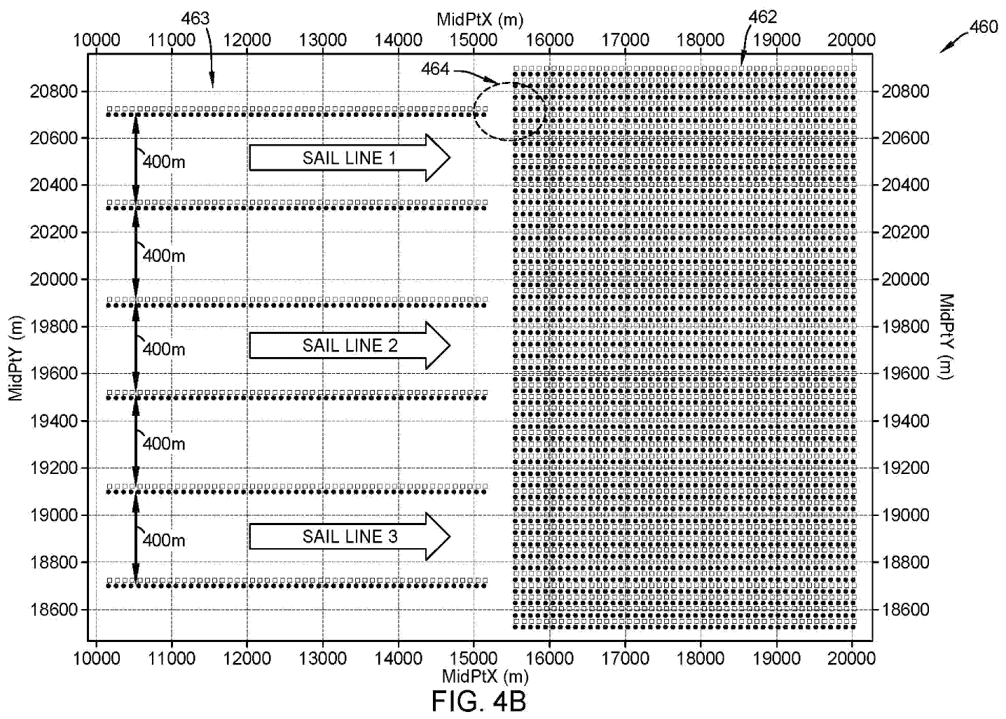

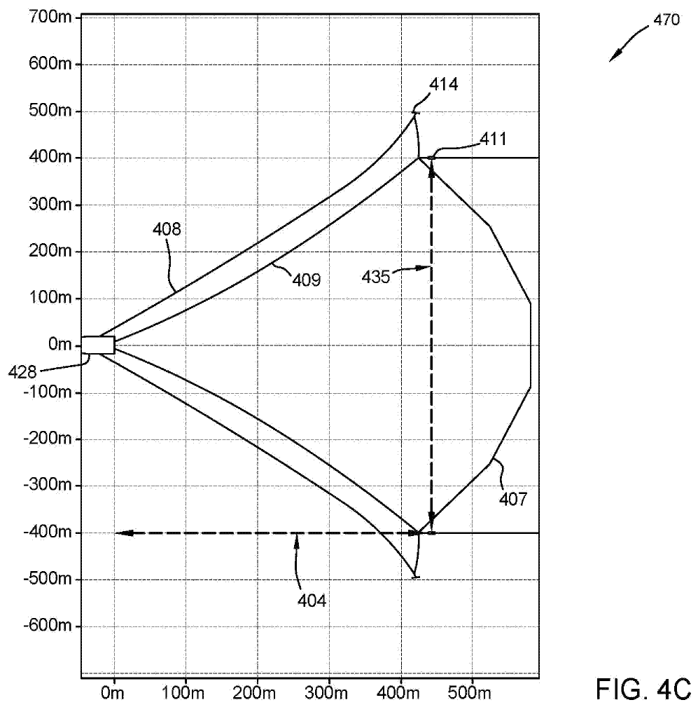

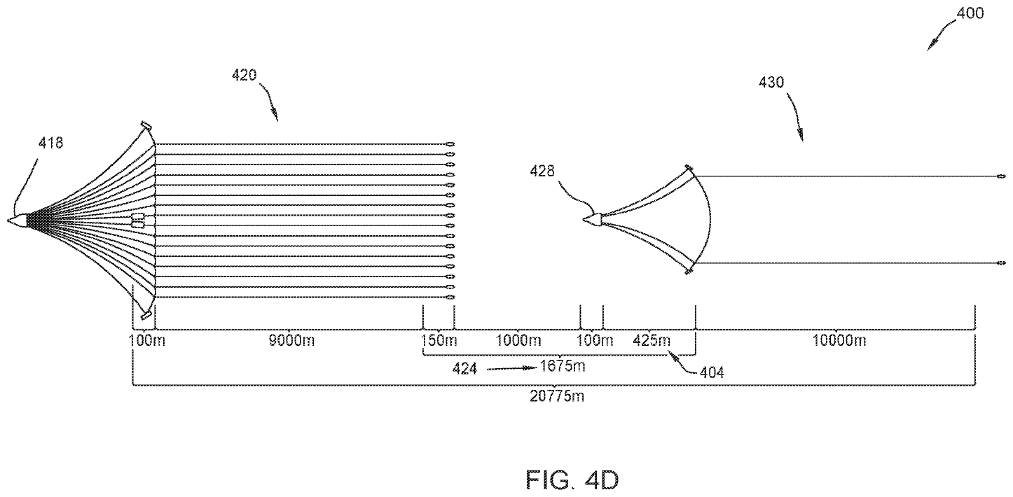

The center of each bin in sampling grid 106 is referred to as the “Common Midpoint” (CMP). Using the flat geology assumption, the location of each subsurface reflection point is at a midpoint between the respective source and receiver coordinates for each wave route. Data detected by receivers (e.g., receivers 122 from FIG. 1A) may be identified with bins from sampling grid 106 based on the CMP of each datum. Such data may be grouped into sublines of data based on the respective bins, resulting in CMP sublines. Thus, a bin may be said to be “populated” by the respective subline when data is acquired for the respective CMP. A bin may be said to be “empty” when data is not acquired for the respective CMP. The survey configuration thereby determines predicted (or nominal) CMP sublines (sometimes referred to simply as “sublines”), as illustrated in FIGS. 4B, 5B, 6B, 7B. The area where the CMP sublines are uniformly distributed for a given acquisition path 180-a may be referred to as an area of uniform CMP coverage. A marine survey may be designed to “tile” areas of uniform CMP coverage from adjacent acquisition paths 180-s so that the entire marine survey area will be uniformly covered.

The number of CMP sublines acquired per sail line, the so-called “CMP brush,” is equal to the product of the number of sources and the number of streamers. The CMP subline spacing depends on the source separations and the streamer separations. Thus, a wider streamer separation produces a wider CMP brush, but may locally result in a sparser crossline sampling density. When acquiring a seismic survey with wide streamer separations, a regular sampling grid can be achieved by means of overlapping the CMP brushes from adjacent sail lines.

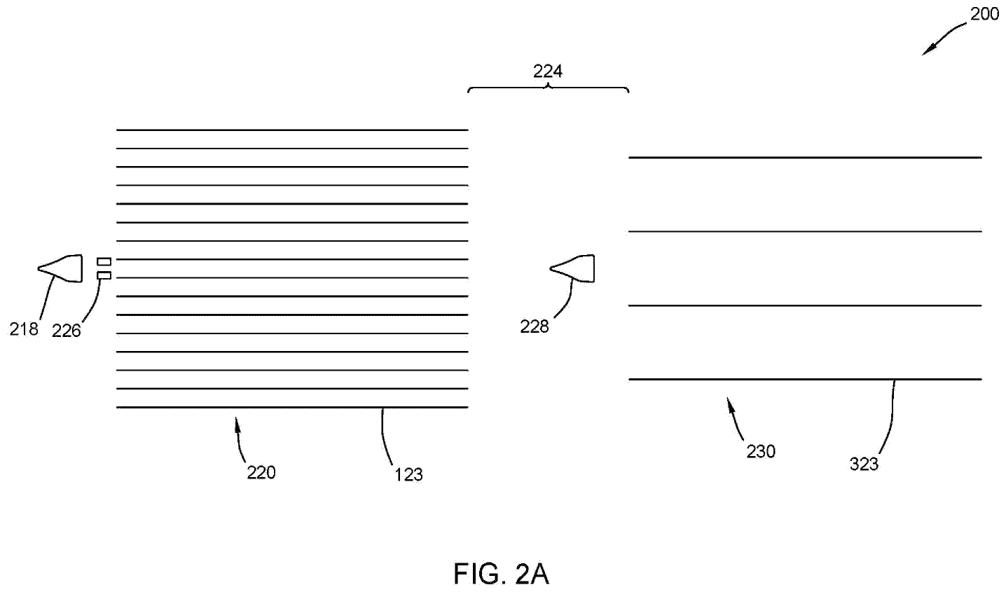

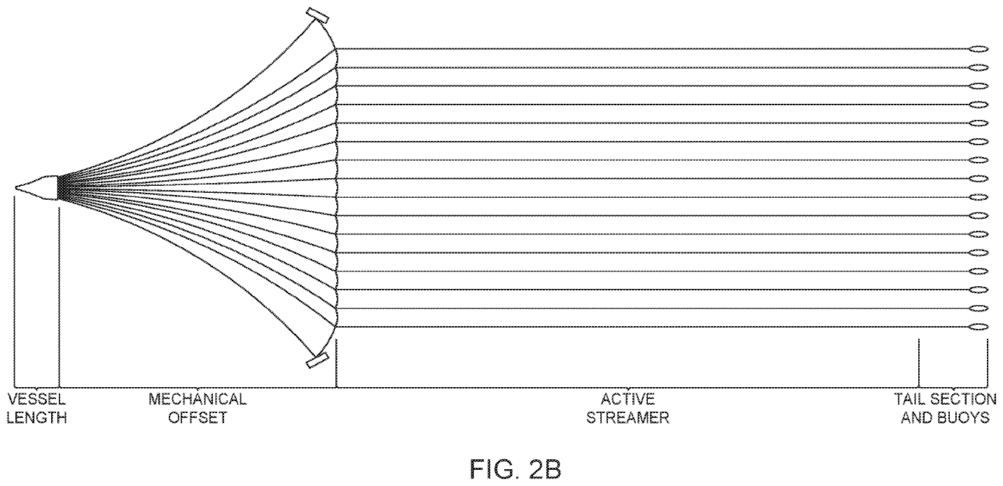

An exemplary Extended Long-Tail (ELT) survey system 200 is illustrated in FIG. 2A. As illustrated, system 200 is configured for multi-streamer long-offset acquisition. In many aspects, system 200 is configured similarly to system 160. However, system 200 includes a long-offset streamer spread 230 (having four long-offset streamers 323) towed by long-offset streamer vessel 228. As illustrated, source vessel 218, near-offset streamer spread 220 (having sixteen near-offset streamers 123), and signal sources 226 represent a NAZ survey configuration, with the signal sources 226 being closer to the midline than either the port-most or starboard-most streamer 123. The long-offset streamer spread 230 may have relatively sparse streamer spacing. For example, the streamer spacing of long-offset streamer spread 230 may be no more dense than the streamer spacing of near-offset streamer spread 220. In other words, the streamer separation between adjacent streamers 323 of long-offset streamer spread 230 may be greater than, or equal to, the streamer separation between adjacent pairs of streamers 123 of near-offset streamer spread 220. The long-offset streamer spread 230 may have a forward-most receiver (not shown) providing a minimum offset (for the long-offset streamer spread 230) of at least about 10 km, for example about 10 km to about 15 km. The long-offset streamer spread 230 may have an aft-most receiver (not shown) providing a maximum offset (for the ELT survey system 200) of at least about 20 km, such as about 20 km to about 50 km.

The ELT survey system 200 may acquire data having ultra-long offsets. As such, the ultra-long-offset data may be utilized for FWI. The ELT survey system 200 may have a reduced amount of equipment in the water and/or environmental exposure as compared to other approaches. For example, long-offset data may be acquired with system 200 while utilizing a single source vessel. As another example, long-offset data may be acquired simultaneously with near-offset data, rather than making multiple passes to acquire the two types of data. The ELT survey system 200 may improve marine survey vessel efficiency (e.g., measured by time, fuel, environmental risks, etc.) by utilizing a streamer vessel, rather than a source vessel to tow long-offset streamer spread 230. Since the ELT survey system 200 does not utilize an additional source vessel, the survey may have a reduced environmental impact as compared to other survey systems. The ELT survey system 200 can allow for easier permitting and/or acquisition of data having significantly longer offsets as compared to other acquisition approaches.

In some embodiments, long-offset streamer spread 230 may include two, three, four, or more long-offset streamers 323. In some embodiments, long-offset streamer spread 230 may allow for regular CMP subline coverage when in combination with data from adjacent sail lines. Note that, for the purposes of regular CMP line coverage, the inline gap 224 between near-offset streamer spread 220 and long-offset streamer spread 230 is inconsequential. In some embodiments, long-offset streamer spread 230 may include any number of streamers, so long as the streamer spacing density in long-offset streamer spread 230 is no greater than the streamer spacing density in near-offset streamer spread 220. The long-offset streamers 323 may include positioning equipment, such as acoustic transducers and/or detectors, that can be used to determine actual and/or relative positioning of the long-offset streamers 323 (e.g., via acoustic bracing).

It is currently believed that towing the near-offset spread 220 and the long-offset spread 230 from two different vessels (e.g., source vessel 218 and long-offset streamer vessel 228) may result in an appreciable inline gap 224 between the two spreads. For example, towing equipment such as tail buoys and lead-in lines may present operational challenges when the long-offset spread 230 follows too closely behind the near-offset spread 220. The resulting inline gap 224 affects the offset used in imaging (maximum near-offset) and the offset used only for FWI (maximum overall offset).

FIG. 2B illustrates an exemplary streamer vessel, such as long-offset streamer vessel 228, towing a streamer spread, such as long-offset streamer spread 230. FIG. 2A also illustrates various elements of the survey system that may be taken into account when calculating the inline gap 224 between near-offset streamer spread 220 and long-offset streamer spread 230, as further discussed below.

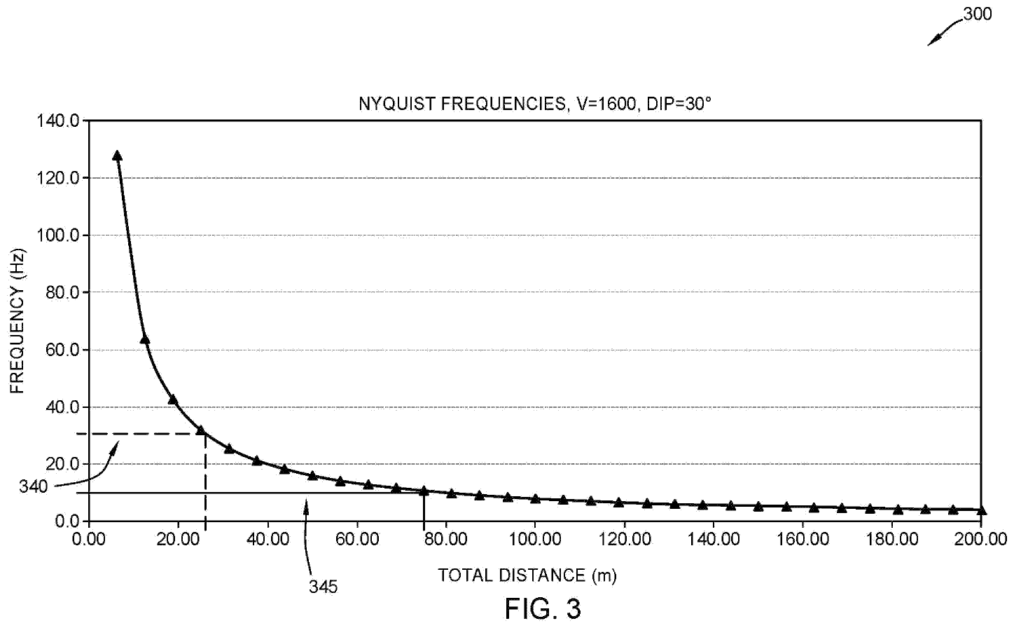

FIG. 3 illustrates a graph 300 of the Nyquist relation of aliased frequencies and spatial sampling for a velocity of 1600 m/s and a dip angle of 30°. The Nyquist relation generally describes at which spatial or temporal sampling it is not possible to reconstruct a wavefield based on the provided sampled data. Since higher frequencies tend to show denser phase variations (e.g., peaks and valleys), the Nyquist relations indicates that waves at higher frequencies require higher sampling densities. For example, sampling high frequency data below the Nyquist threshold may result in two sampled data points falling onto two adjacent peaks without describing the valley between the two peaks, resulting in information loss. Line 340 of FIG. 3 illustrates data acquired with a NAZ survey configuration, having frequencies up to 32 Hz for 25 m sampling. Line 345 illustrates data acquired with an ELT survey system, having frequencies up to 10 Hz for 75 m sampling. As illustrated, for low frequency applications such as FWI, crossline sampling density can be substantially sparser than data used for imaging. In other words, Nyquist limitations may be satisfied with larger trace distances as frequencies are lower.

FIG. 4A illustrates another exemplary ELT survey system 400 in accordance with the present disclosure. In many aspects, system 400 is configured similarly to system 200. However, system 400 includes a long-offset streamer spread 430 having two long-offset streamers 323. As illustrated, source vessel 418, near-offset streamer spread 420, and signal sources 426 represent a NAZ survey configuration, with the signal sources 426 being closer to the midline than either the port-most or starboard-most streamer 123. For example, the NAZ survey configuration may include sixteen near-offset streamers 123 (e.g., streamer lengths of about 5 km to about 12 km). The near-offset streamer spread 420 may have an overall spread width 445 of about 1500 m. For example, adjacent near-offset streamers 123 may be separated by about 100 m. The ELT survey system 400 also includes a long-offset streamer vessel (not shown) towing long-offset streamer spread 430. For example, the long-offset streamer spread 430 may include two long-offset streamers 323 (e.g., streamer lengths of about 5 km to about 12 km). The long-offset streamer spread 430 may have relatively sparse streamer spacing (i.e., the streamer spacing of long-offset streamer spread 430 may be no more dense than the streamer spacing of near-offset streamer spread 420). The long-offset streamers 323 may include positioning equipment, such as acoustic transducers and/or detectors, that can be used to determine actual and/or relative positioning of the long-offset streamers 323 (e.g., via acoustic bracing). The long-offset streamer spread 430 may have a forward-most receiver (not shown) providing a minimum offset (for the long-offset streamer spread 430) of at least about 10 km, for example about 10 km to about 15 km. The long-offset streamer spread 430 may have an aft-most receiver (not shown) providing a maximum offset (for the ELT survey system 400) of at least about 20 km, such as about 20 km to about 50 km.

Adjacent streamers 323 of long-offset streamer spread 430 may have a streamer separation 435 of about 800 m. For example, the streamers 323 of the long-offset streamer spread 430 may accommodate eight streamers of the near-offset streamer spread 420 in between them. As illustrated, on both the port side and the starboard side, four streamers 123 of near-offset streamer spread 420 are outside of long-offset streamer spread 430. In at least one embodiment, the long-offset streamer vessel (not shown) may steer above (i.e., at a shallower depth) the towing depth of the near-offset streamer spread 420. In other words, to reduce the inline gap 424 (illustrated in FIG. 4D), the long-offset streamer vessel (not shown) of system 400 may be positioned inline near or proximally with the aft section of near-offset streamer spread 420.

FIG. 4B illustrates an exemplary CMP distribution 460 corresponding to the ELT survey system 400 of FIG. 4A. As illustrated, CMP distribution 460 represents data for two successive shots on each of three adjacent sail lines. Note that data acquired with long-offset survey spread 430 (having two long-offset streamers 323 with streamer separation 435 of about 400 m) results in evenly spaced CMP lines in CMP distribution 460. Specifically, the CMP line spacing is about 400 m for each sail line, and about 400 m between sail lines. Note also that the long-offset CMP lines 463 are not continuations of the near-offset CMP lines 462, as can be seen, for example, in region 464.

FIG. 4C illustrates an exemplary towing lead-in configuration 470 for long-offset streamer spread 430 of ELT survey system 400. As illustrated, long-offset streamers (not shown) of the long-offset streamer spread (not shown) are coupled to long-offset streamer vessel 428 via lead-in lines 409 and lead-in terminations 411. Lead-in terminations 411 may be coupled to or associated with spreader line 407 so as to nominally fix the lateral positions of long-offset streamers with respect to each other and with respect to a centerline of long-offset streamer vessel 428. As shown, towing lead-in configuration 470 may also include two paravanes 414 coupled to long-offset streamer vessel 428 via paravane tow lines 408. As illustrated, in order to achieve a streamer separation 435 of about 800 m, the towing lead-in configuration 470 would have a lead-in distance 404 of about 425 m. Note that the lead-in distance 404 measures the inline distance between long-offset streamer vessel 428 and the forward-most portion of long-offset streamer spread 430 (see FIG. 4D), as indicated by lead-in terminations 411. In some embodiments, lead-in distance 404 may contribute to the inline gap 424 (illustrated in FIG. 4D) between near-offset streamer spread 420 and long-offset streamer spread 430.

FIG. 4D illustrates another view of exemplary ELT survey system 400. FIG. 4D illustrates various elements of the ELT survey system 400 that may be taken into account when calculating the inline gap 424 between near-offset streamer spread 420 and long-offset streamer spread 430. Namely, to calculate the inline gap 424 in the illustrated embodiment, add the following elements:
Near-offset streamer spread 420 aft section: 150 m
Safety zone: 1000 m
long-offset streamer vessel 428 length: 100 m
lead-in distance 404: 425 m
   In the illustrated embodiment, the resulting inline gap 424 between near-offset streamer spread 420 and long-offset streamer spread 430 is about 1675 m. Likewise, the overall maximum inline offset over all of the elements adds up to about 20,775 m. These measurements represent example values that may pertain to embodiments disclosed herein, and a variety of other measurements may be suitable for ELT survey systems.

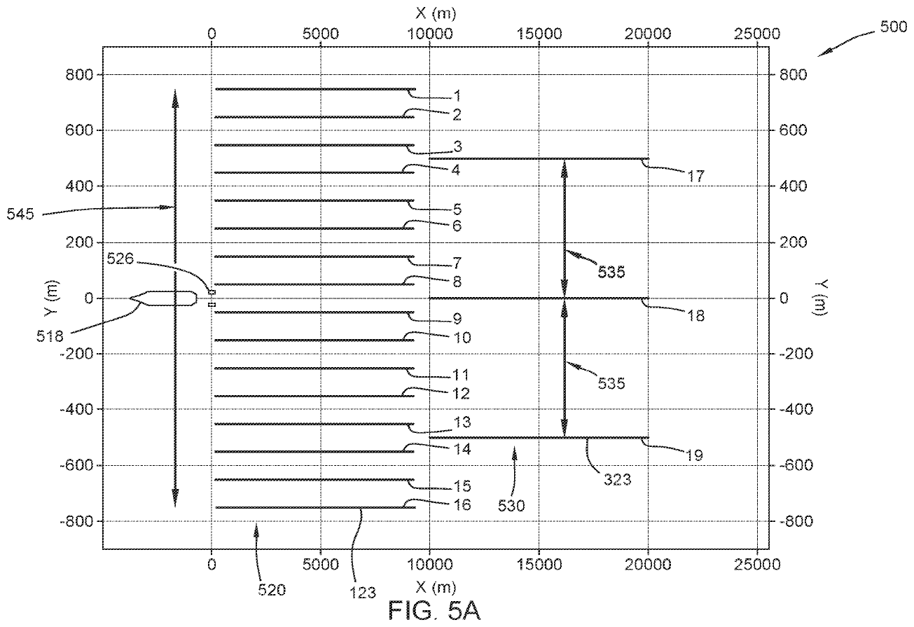

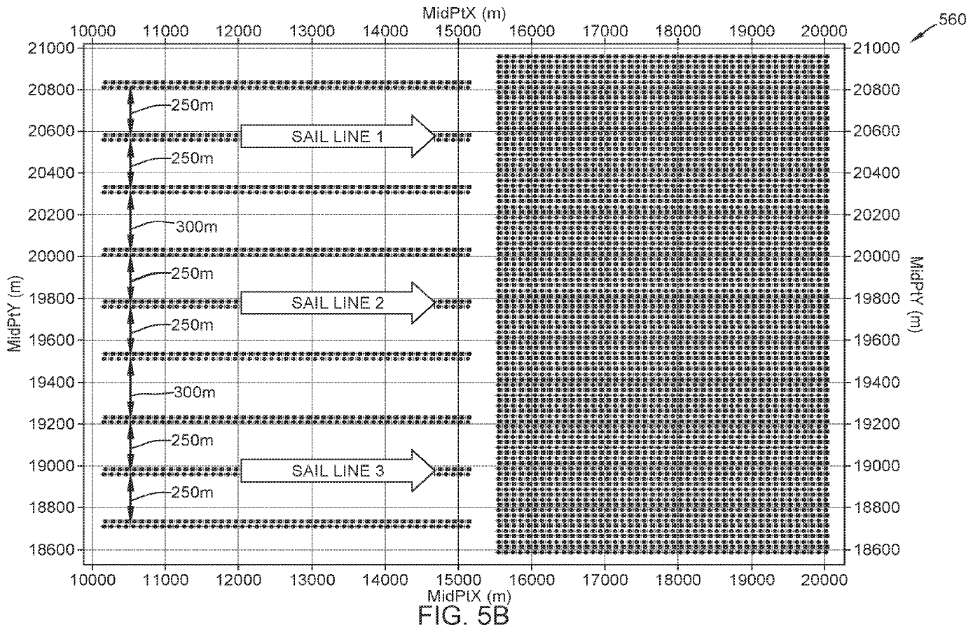

FIG. 5A illustrates another exemplary ELT survey system 500 in accordance with the present disclosure. In many aspects, system 500 is configured similarly to systems 200, 400. However, system 500 includes a long-offset streamer spread 530 having three long-offset streamers 323. As illustrated, source vessel 518, near-offset streamer spread 520, and signal sources 526 represent a NAZ survey configuration, with the signal sources 526 being closer to the midline than either the port-most or starboard-most streamer 123. For example, the NAZ survey configuration may include sixteen near-offset streamers 123 (e.g., streamer lengths of about 5 km to about 12 km). The near-offset streamer spread 520 may have an overall spread width 545 of about 1500 m. For example, adjacent near-offset streamers 123 may be separated by about 100 m. The ELT survey system 500 also includes a long-offset streamer vessel (not shown) towing long-offset streamer spread 530. For example, the long-offset streamer spread 530 may include three streamers 323 with long offsets (e.g., streamer lengths of about 5 km to about 12 km). The long-offset streamer spread 530 may have relatively sparse streamer spacing (i.e., the streamer spacing of long-offset streamer spread 530 may be no more dense than the streamer spacing of near-offset streamer spread 520). The long-offset streamers 323 may include positioning equipment, such as acoustic transducers and/or detectors, that can be used to determine actual and/or relative positioning of the long-offset streamers 323 (e.g., via acoustic bracing). The long-offset streamer spread 530 may have a forward-most receiver (not shown) providing a minimum offset (for the long-offset streamer spread 530) of at least about 10 km, for example about 10 km to about 15 km. The long-offset streamer spread 530 may have an aft-most receiver (not shown) providing a maximum offset (for the ELT survey system 500) of at least about 20 km, such as about 20 km to about 50 km.

Adjacent streamers 323 of long-offset streamer spread 530 may have a streamer separation 535 of about 500 m. The overall width of long-offset streamer spread 530 may be about 1000 m. For example, adjacent pairs of the streamers 323 of the long-offset streamer spread 530 may accommodate ten streamers 123 of the near-offset streamer spread 520 in between them. As illustrated, on both the port side and the starboard side, three streamers 123 of near-offset streamer spread 520 are outside of long-offset streamer spread 530. In at least one embodiment, the long-offset streamer vessel (not shown) may steer above (i.e., at a shallower depth) the towing depth of the near-offset streamer spread 520 to allow for lead-in. It is currently believed that an uneven number of long-offset streamers 323 in long-offset streamer spread 530 may result in a potential increase in crossline spacing between sail lines.

FIG. 5B illustrates an exemplary CMP distribution 560 corresponding to the ELT survey system 500 of FIG. 5A. As illustrated, CMP distribution 560 represents data for two successive shots on each of three adjacent sail lines. Note that data acquired with long-offset survey spread 530 (having three long-offset streamers 323 with streamer separation 535 of about 500 m) results in unevenly spaced CMP lines in CMP distribution 560. Specifically, the CMP line spacing about 250 m for each sail line, and about 300 m between sail lines. Note also that the long-offset CMP lines 563 are not continuations of the near-offset CMP lines 562, as can be seen, for example, in region 564.

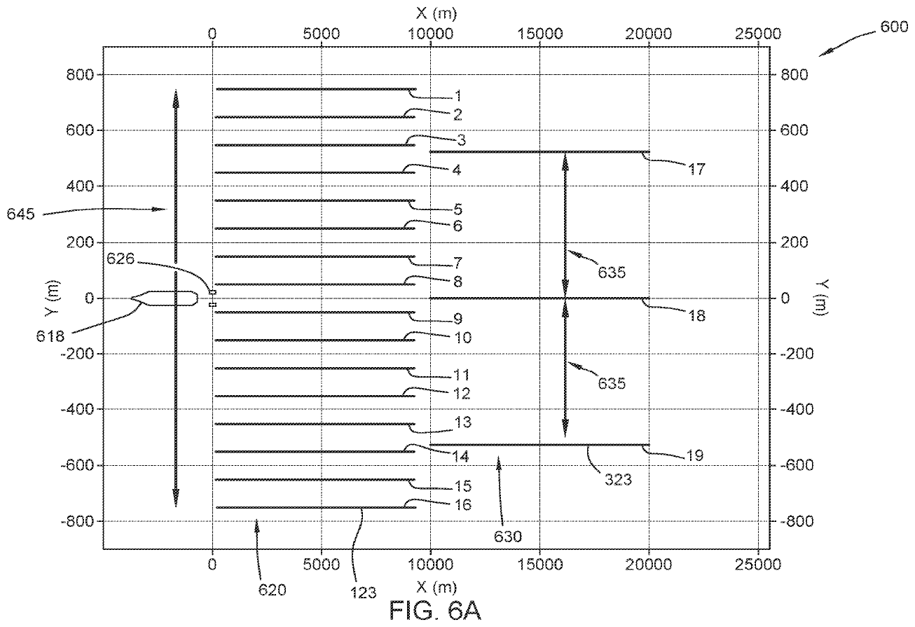

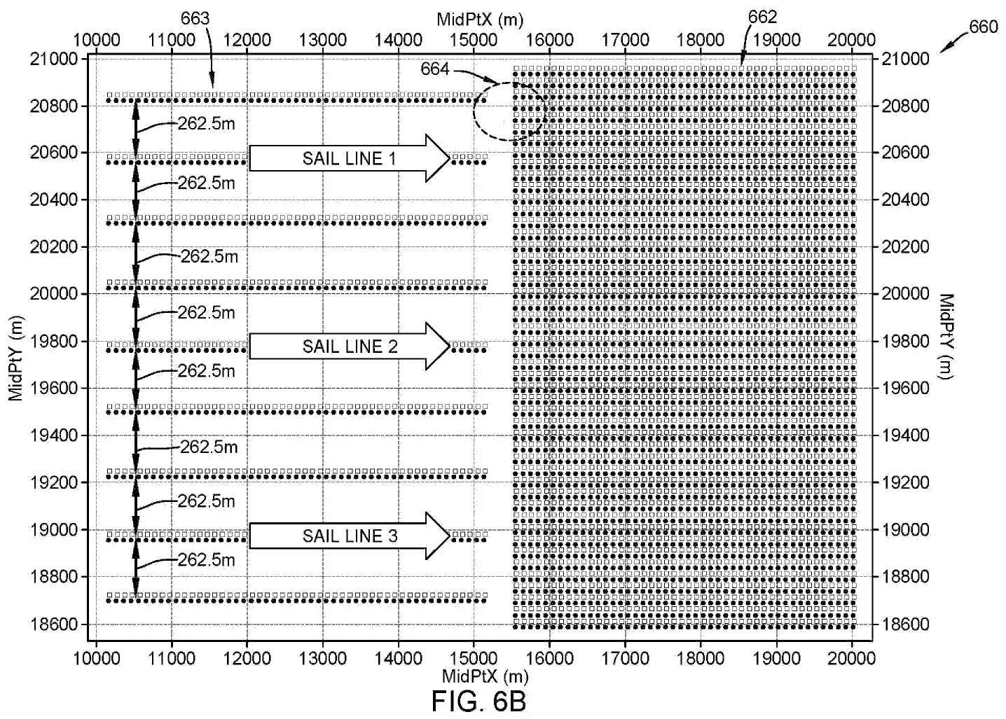

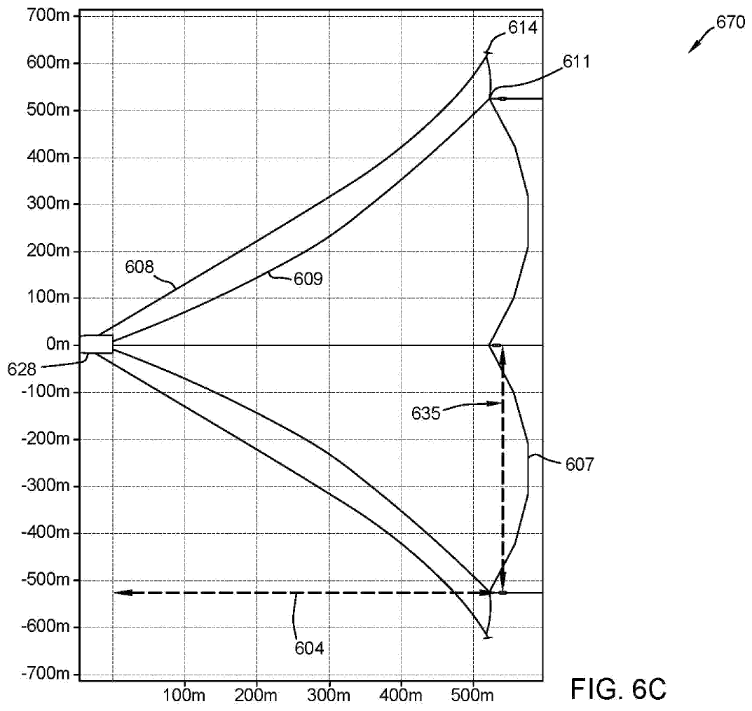

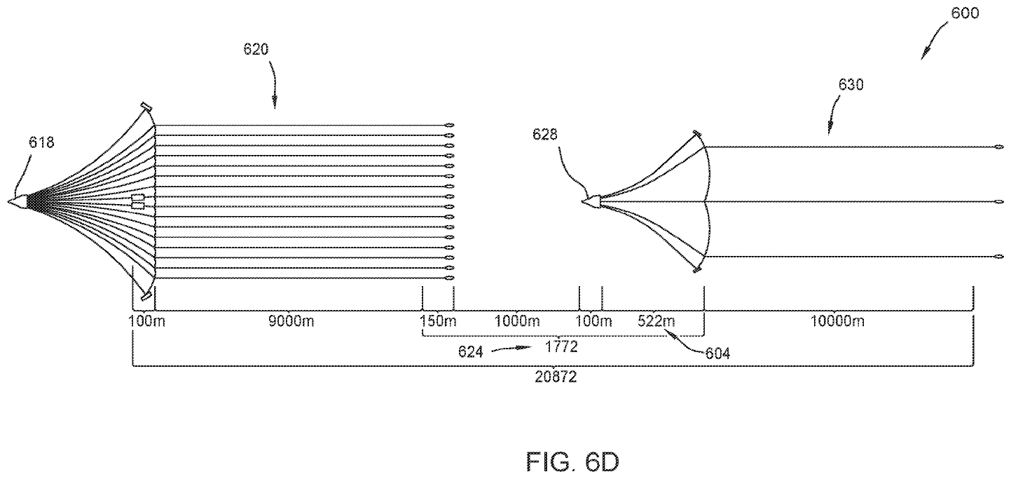

FIG. 6A illustrates another exemplary ELT survey system 600 in accordance with the present disclosure. In many aspects, system 600 is configured similarly to system 500. However, system 600 includes a larger streamer separation 635 of about 525 m between adjacent pairs of long-offset streamers 323 in long-offset streamer spread 630. The overall width of long-offset streamer spread 630 may be about 1050 m. It is currently believed that this modification may result in CMP lines being slightly displaced, however the CMP line spacing to the adjacent sail lines may remain regular.

FIG. 6B illustrates an exemplary CMP distribution 660 corresponding to the ELT survey system 600 of FIG. 6A. As illustrated, CMP distribution 660 represents data for two successive shots on each of three adjacent sail lines. Note that data acquired with long-offset survey spread 630 (having three long-offset streamers 323 with streamer separation 635 of about 525 m) results in evenly spaced CMP lines in CMP distribution 660. Specifically, the CMP line spacing is about 262.5 m for each sail line, and about 262.5 m between sail lines. Note also that the long-offset CMP lines 663 are not continuations of the near-offset CMP lines 662, as can be seen, for example, in region 664.

FIG. 6C illustrates an exemplary towing lead-in configuration 670 for the long-offset streamer spread 630 of ELT survey system 600. As illustrated, long-offset streamers (not shown) of the long-offset streamer spread (not shown) are coupled to long-offset streamer vessel 628 via lead-in lines 609 and lead-in terminations 611. Lead-in terminations 611 may be coupled to or associated with spreader line 607 so as to nominally fix the lateral positions of long-offset streamers with respect to each other and with respect to a centerline of long-offset streamer vessel 628. As shown, towing lead-in configuration 470 may also include two paravanes 614 coupled to long-offset streamer vessel 628 via paravane tow lines 608. As illustrated, in order to achieve a streamer separation 635 of about 525 m, the towing lead-in configuration 670 would have a lead-in distance 604 of about 522 m. In some embodiments, lead-in distance 604 may contribute to the inline gap 624 (illustrated in FIG. 6D) between near-offset streamer spread 620 and long-offset streamer spread 630.

FIG. 6D illustrates another view of exemplary ELT survey system 600. FIG. 6D illustrates various elements of the ELT survey system 600 that may be taken into account when calculating the inline gap 624 between near-offset streamer spread 620 and long-offset streamer spread 630. Namely, to calculate the inline gap 624 in the illustrated embodiment, add the following elements:
Near-offset streamer spread 620 aft section: 150 m
Safety zone: 1000 m
long-offset streamer vessel 628 length: 100 m
lead-in distance 604: 522 m
   In the illustrated embodiment, the resulting inline gap 624 between near-offset streamer spread 620 and long-offset streamer spread 630 is about 1772 m. Likewise, the overall maximum inline offset over all of the elements adds up to about 20,872 m. These measurements represent example values that may pertain to embodiments disclosed herein, and a variety of other measurements may be suitable for ELT survey systems.

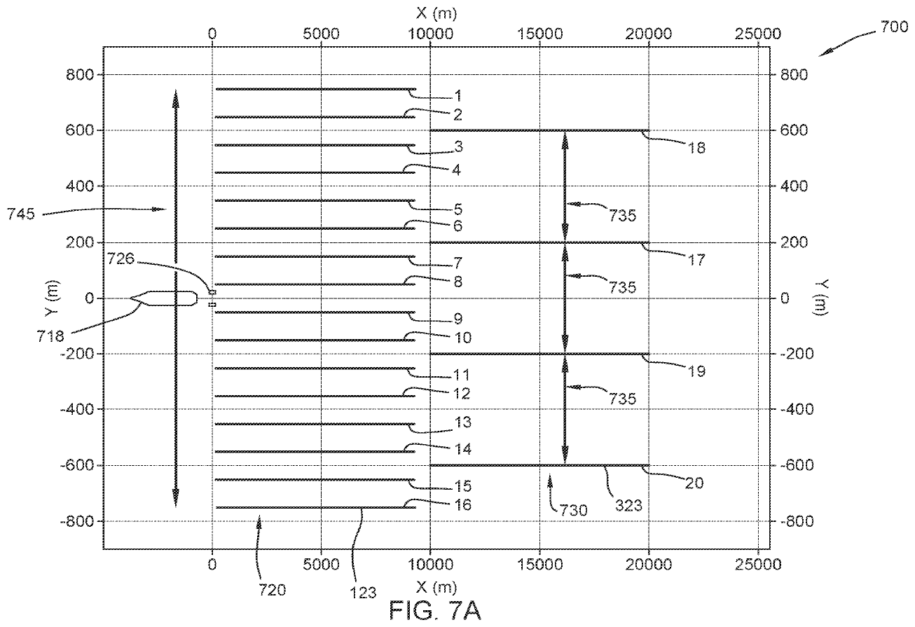

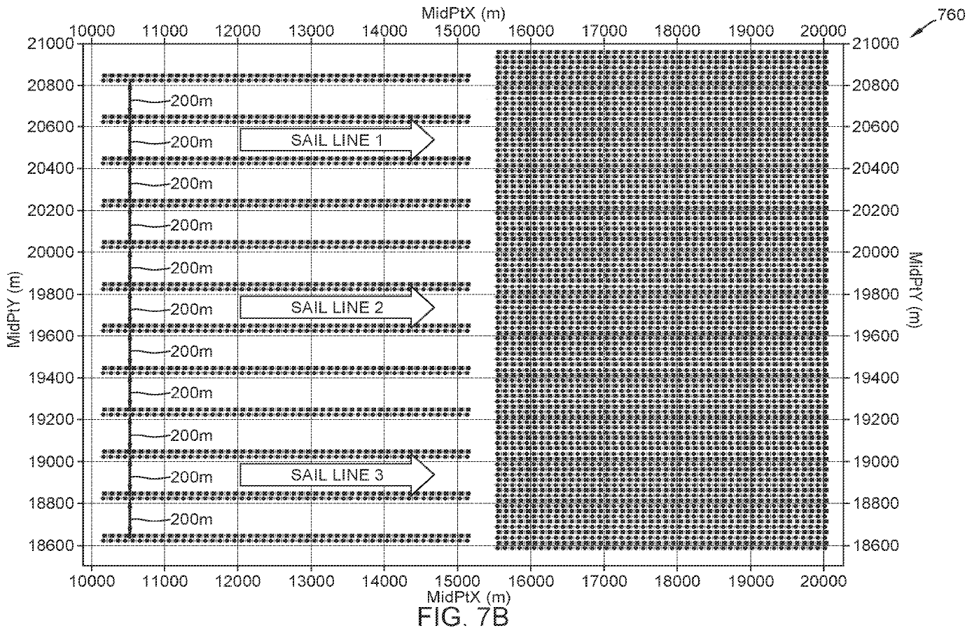

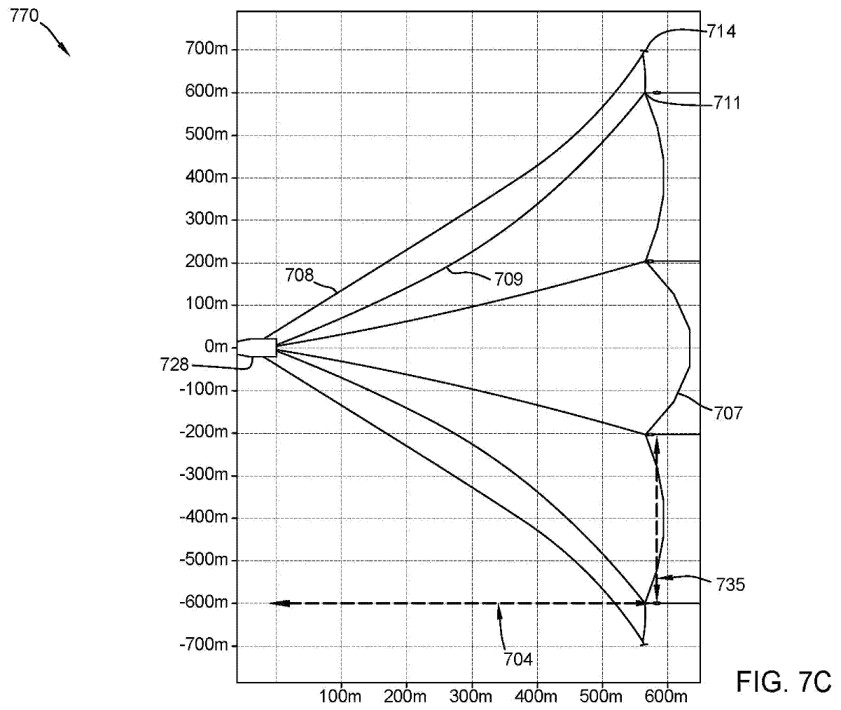

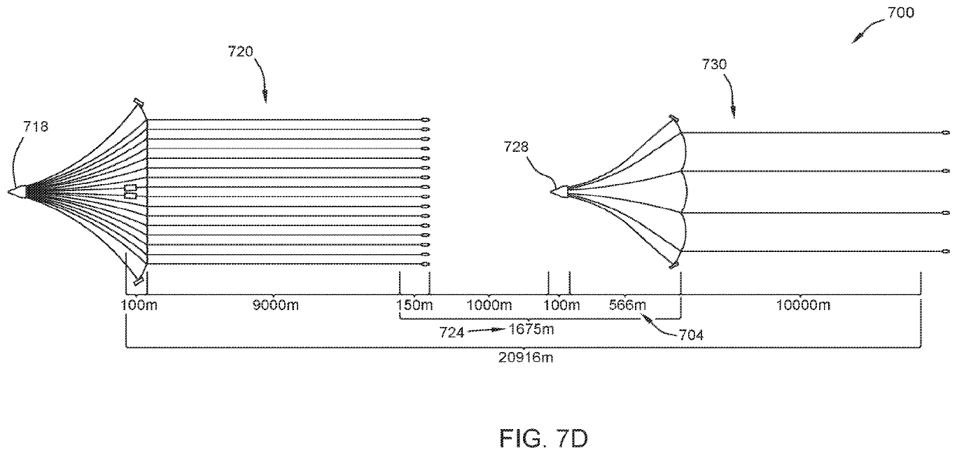

FIG. 7A illustrates another exemplary ELT survey system 700 in accordance with the present disclosure. In many aspects, system 700 is configured similarly to systems 200, 400, 500, 600. However, system 700 includes a long-offset streamer spread 730 having four long-offset streamers 323. As illustrated, source vessel 718, near-offset streamer spread 720, and signal sources 726 represent a NAZ survey configuration, with the signal sources 726 being closer to the midline than either the port-most or starboard-most streamer 123. For example, the NAZ survey configuration may include sixteen near-offset streamers 123 (e.g., streamer lengths of about 5 km to about 12 km). The near-offset streamer spread 720 may have an overall spread width 745 of about 1500 m. For example, adjacent streamers 123 may be separated by about 100 m. The ELT survey system 700 also includes a long-offset streamer vessel (not shown) towing long-offset streamer spread 730. For example, the long-offset streamer spread 730 may include four streamers 323 with long offsets (e.g., streamer lengths of about 5 km to about 12 km). The long-offset streamer spread 730 may have relatively sparse streamer spacing (i.e., the streamer spacing of long-offset streamer spread 730 may be no more dense than the streamer spacing of near-offset streamer spread 720). The long-offset streamers 323 may include positioning equipment, such as acoustic transducers and/or detectors, that can be used to determine actual and/or relative positioning of the long-offset streamers 323 (e.g., via acoustic bracing). The long-offset streamer spread 730 may have a forward-most receiver (not shown) providing a minimum offset (for the long-offset streamer spread 730) of at least about 10 km, for example about 10 km to about 15 km. The long-offset streamer spread 730 may have an aft-most receiver (not shown) providing a maximum offset (for the ELT survey system 700) of at least about 20 km, such as about 20 km to about 50 km.

Adjacent streamers 323 of long-offset streamer spread 730 may have a streamer separation 735 of about 400 m. The overall width of long-offset streamer spread 730 may be about 1200 m. For example, adjacent pairs of the streamers 323 of the long-offset streamer spread 730 may accommodate twelve streamers of the near-offset streamer spread 720 in between them. As illustrated, on both the port side and the starboard side, two streamers 123 of near-offset streamer spread 720 are outside of long-offset streamer spread 730. In at least one embodiment, the long-offset streamer vessel (not shown) may steer above (i.e., at a shallower depth) the towing depth of the near-offset streamer spread 720 to allow for lead-in. It is currently believed that an even number of streamers 323 in long-offset streamer spread 730 may result in regular CMP line coverage.

FIG. 7B illustrates an exemplary CMP distribution 760 corresponding to the ELT survey system 700 of FIG. 7A. As illustrated, CMP distribution 760 represents data for two successive shots on each of three adjacent sail lines. Note that data acquired with long-offset survey spread 730 (having four long-offset streamers 323 with streamer separation 735 of about 400 m) results in evenly spaced CMP lines in CMP distribution 760. Specifically, the CMP line spacing is about 200 m for each sail line, and about 200 m between sail lines. Note also that CMP distribution 760 provides a more dense CMP coverage than CMP distributions 460, 660. Note also that the long-offset CMP lines 763 are continuations of the near-offset CMP lines 762, as can be seen, for example, in region 764.

FIG. 7C illustrates an exemplary towing lead-in configuration 770 for long-offset streamer spread 730 of ELT survey system 700. As illustrated, long-offset streamers (not shown) of the long-offset streamer spread (not shown) are coupled to long-offset streamer vessel 728 via lead-in lines 709 and lead-in terminations 711. Lead-in terminations 711 may be coupled to or associated with spreader line 707 so as to nominally fix the lateral positions of long-offset streamers with respect to each other and with respect to a centerline of long-offset streamer vessel 728. As shown, towing lead-in configuration 770 may also include two paravanes 714 coupled to long-offset streamer vessel 728 via paravane tow lines 708. As illustrated, in order to achieve a streamer separation 735 of about 400 m, the towing lead-in configuration 770 would have a lead-in distance 704 of about 566 m. In some embodiments, lead-in distance 704 may contribute to the inline gap 724 (illustrated in FIG. 7D) between near-offset streamer spread 720 and long-offset streamer spread 730.

FIG. 7D illustrates another view of exemplary ELT survey system 700. FIG. 7D illustrates various elements of the ELT survey system 700 that may be taken into account when calculating the inline gap 724 between near-offset streamer spread 720 and long-offset streamer spread 730. Namely, to calculate the inline gap 724 in the illustrated embodiment, add the following elements:
Near-offset streamer spread 720 aft section: 150 m
Safety zone: 1000 m
long-offset streamer vessel 728 length: 100 m
lead-in distance 704: 566 m
   In the illustrated embodiment, the resulting inline gap 724 between near-offset streamer spread 720 and long-offset streamer spread 730 is about 1816 m. Likewise, the overall maximum inline offset over all of the elements adds up to about 20,916 m. These measurements represent example values that may pertain to embodiments disclosed herein, and a variety of other measurements may be suitable for ELT survey systems.

FIG. 8 illustrates another exemplary ELT survey system 800 in accordance with the present disclosure. In many aspects, system 800 is configured similarly to systems 200, 400, 500, 600, 700. However, system 800 includes a long-offset streamer spread 830 having sixteen long-offset streamers 323. As illustrated, source vessel 818, near-offset streamer spread 820, and signal sources 826 represent a NAZ survey configuration, with the signal sources 826 being closer to the midline than either the port-most or starboard-most streamer 123. For example, the NAZ survey configuration may include sixteen near-offset streamers 123 (e.g., streamer lengths of about 5 km to about 12 km). The ELT survey system 800 also includes a long-offset streamer vessel 828 towing long-offset streamer spread 830. For example, the long-offset streamer spread 830 may include sixteen streamers 323 with long offsets (e.g., streamer lengths of about 5 km to about 12 km). The long-offset streamer spread 830 may have relatively sparse streamer spacing (i.e., the streamer spacing of long-offset streamer spread 830 may be no more dense than the streamer spacing of near-offset streamer spread 820). The long-offset streamers 323 of long-offset streamer spread 830 may include positioning equipment, such as acoustic transducers and/or detectors, that can be used to determine actual and/or relative positioning of the long-offset streamers 323 (e.g., via acoustic bracing). The long-offset streamer spread 830 may have a forward-most receiver (not shown) providing a minimum offset (for the long-offset streamer spread 830) of at least about 10 km, for example about 10 km to about 15 km. The long-offset streamer spread 830 may have an aft-most receiver (not shown) providing a maximum offset (for the ELT survey system 800) of at least about 20 km, such as about 20 km to about 50 km.

FIG. 8 also illustrates various elements of the ELT survey system 800 that may be taken into account when calculating the inline gap 824 between near-offset streamer spread 820 and long-offset streamer spread 830. The resulting inline gap 824 is about 2000 m. The overall maximum inline offset over all of the elements adds up to about 22,000 m.

As previously described, long-offset data may be obtained by towing a long-offset streamer spread behind a near-offset streamer spread. For example, in systems 200, 400, 500, 600, 700, and 800, a streamer vessel (towing a long-offset streamer spread) follows the path of a source vessel (towing a near-offset streamer spread). As would be appreciated by one of ordinary skill in the art with the benefit of this disclosure, long-offset data also may be obtained by towing a long-offset streamer spread in front of a near-offset streamer spread. For example, in any of systems 200, 400, 500, 600, 700, and 800, the order of the source vessel and the streamer vessel may be reversed. To give a specific example, system 700 may be modified by operating streamer vessel 728 (still towing long-offset streamer spread 730) along a survey path. Source vessel 718 (still towing sources 726 and near-offset streamer spread 720) would follow streamer vessel along that survey path. An inline gap 724′ would separate the two streamer spread, where inline gap 724′ would include (at least) allowance for long-offset streamer spread 730 aft section, safety zone, source vessel 718 length, and lead-in distance (for source vessel 718). Note that inline gap 724′ may also be increased to increase the maximum offset of the long-offset data.

As previously described, long-offset data may be obtained by towing a single long-offset streamer spread behind a near-offset streamer spread. For example, in systems 200, 400, 500, 600, 700, and 800, a single streamer vessel (towing a long-offset streamer spread) follows the path of a source vessel (towing a near-offset streamer spread). As would be appreciated by one of ordinary skill in the art with the benefit of this disclosure, long-offset data also may be obtained by towing multiple long-offset streamer spreads along (either preceding or following) the path of a near-offset streamer spread. For example, in any of systems 200, 400, 500, 600, 700, and 800, the source vessel may be followed by a first streamer vessel towing a first long-offset streamer spread, and the first streamer vessel may be followed by a second streamer vessel towing a second long-offset streamer spread. As would be appreciated by one of ordinary skill in the art with the benefit of this disclosure, the order of the source vessel, the first streamer vessel, and the second streamer vessel may be interchanged. For example, source-streamer-streamer, or streamer-source-streamer, or streamer-streamer-source would each be an acceptable ordering.

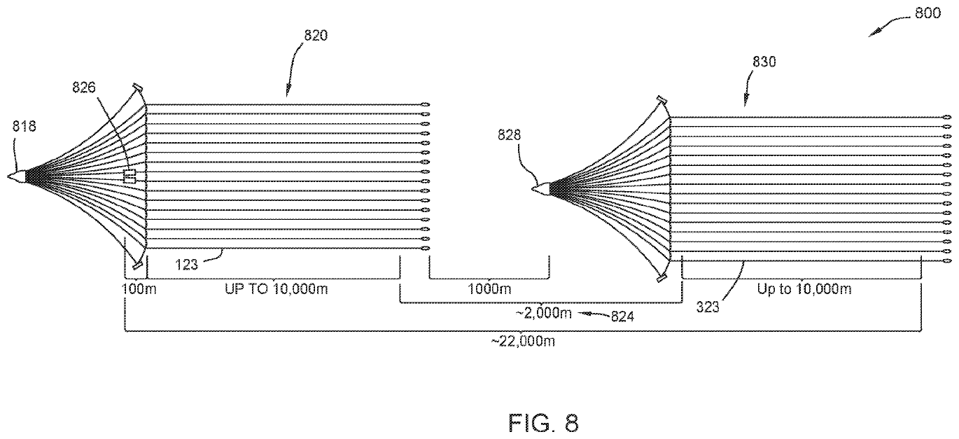

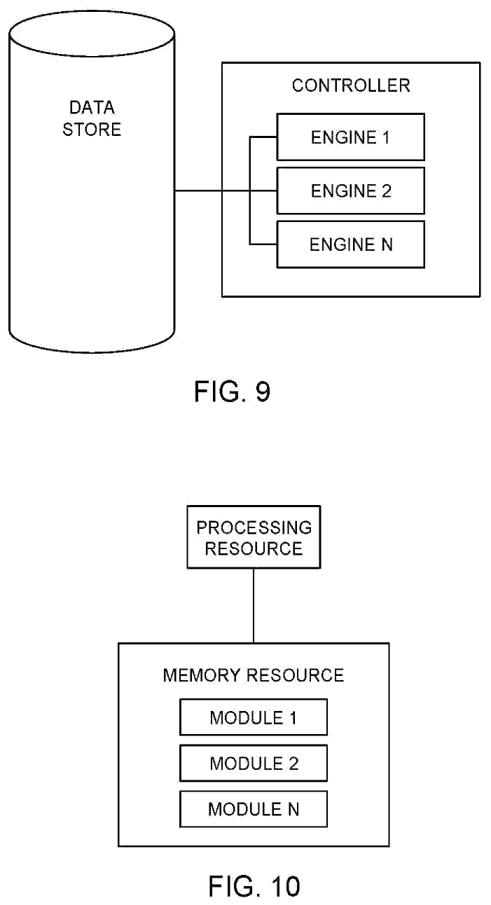

FIG. 9 illustrates an exemplary system for a surveying method with ELT survey systems. The system can include a data store and a controller coupled to the data store. The controller can be analogous to the controller described with respect to FIG. 1A. The data store can store marine seismic survey data.

The controller can include a number of engines (e.g., engine 1, engine 2, . . . engine N) and can be in communication with the data store via a communication link. The system can include additional or fewer engines than illustrated to perform the various functions described herein. As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, etc.

The number of engines can include a combination of hardware and program instructions that is configured to perform a number of functions described herein. The program instructions, such as software, firmware, etc., can be stored in a memory resource such as a machine-readable medium or as a hard-wired program such as logic. Hard-wired program instructions can be considered as both program instructions and hardware.

The controller can be configured, for example, via a combination of hardware and program instructions in the number of engines for methods utilizing an ELT survey system. For example, a first engine (e.g., engine 1) can be configured to actuate sources, process data, and/or acquire data gathered during acquisition using an ELT survey system.

FIG. 10 illustrates an exemplary machine for an ELT surveying method. In at least one embodiment, the machine can be analogous to the system illustrated in FIG. 9. The machine can utilize software, hardware, firmware, and/or logic to perform a number of functions. The machine can be a combination of hardware and program instructions configured to perform a number of functions (e.g., actions). The hardware, for example, can include a number of processing resources and a number of memory resources, such as a machine-readable medium or other non-transitory memory resources. The memory resources can be internal and/or external to the machine, for example, the machine can include internal memory resources and have access to external memory resources. The program instructions, such as machine-readable instructions, can include instructions stored on the machine-readable medium to implement a particular function. The set of machine-readable instructions can be executable by one or more of the processing resources. The memory resources can be coupled to the machine in a wired and/or wireless manner. For example, the memory resources can be an internal memory, a portable memory, a portable disk, and/or a memory associated with another resource, for example, enabling machine-readable instructions to be transferred and/or executed across a network such as the Internet. As used herein, a “module” can include program instructions and/or hardware, but at least includes program instructions.

The memory resources can be non-transitory and can include volatile and/or non-volatile memory. Volatile memory can include memory that depends upon power to store information, such as various types of dynamic random-access memory among others. Non-volatile memory can include memory that does not depend upon power to store information. Examples of non-volatile memory can include solid state media such as flash memory, electrically erasable programmable read-only memory, phase change random access memory, magnetic memory, optical memory, and/or a solid-state drive, etc., as well as other types of non-transitory machine-readable media.

The processing resources can be coupled to the memory resources via a communication path. The communication path can be local to or remote from the machine. Examples of a local communication path can include an electronic bus internal to a machine, where the memory resources are in communication with the processing resources via the electronic bus. Examples of such electronic buses can include Industry Standard Architecture, Peripheral Component Interconnect, Advanced Technology Attachment, Small Computer System Interface, Universal Serial Bus, among other types of electronic buses and variants thereof. The communication path can be such that the memory resources are remote from the processing resources, such as in a network connection between the memory resources and the processing resources. That is, the communication path can be a network connection. Examples of such a network connection can include a local area network, wide area network, personal area network, and the Internet, among others.

Although not specifically illustrated in FIG. 10, the memory resources can store marine seismic survey data. As is shown in FIG. 10, the machine-readable instructions stored in the memory resources can be segmented into a number of modules (e.g., module 1, module 2, . . . module N) that when executed by the processing resources can perform a number of functions. As used herein a module includes a set of instructions included to perform a particular task or action. The number of modules can be sub-modules of other modules. For example, module 1 can be a sub-module of module 2. Furthermore, the number of modules can comprise individual modules separate and distinct from one another. Examples are not limited to the specific modules illustrated in FIG. 10.

In at least one embodiment of the present disclosure, a first module (e.g., module 1) can include program instructions and/or a combination of hardware and program instructions that, when executed by a processing resource, can actuate sources, process data, and/or acquire data gathered during acquisition using an ELT surveying system and/or method.

In accordance with a number of embodiments of the present disclosure, a geophysical data product may be manufactured. The geophysical data product may be indicative of certain properties of a subterranean formation. The geophysical data product may include and/or be manufactured with, for example, survey data, seismic data, electromagnetic data, pressure data, particle motion data, particle velocity data, particle acceleration data, long-offset data, and any seismic image that results from using the methods and systems described above. The geophysical data product may be stored on a tangible and/or non-transitory computer-readable media. The geophysical data product may be produced by processing geophysical data offshore (i.e. by equipment on a vessel) or onshore (i.e. at a facility on land) either within the United States or in another country. If the geophysical data product is produced offshore or in another country, it may be imported onshore to a facility in the United States. For example, the geophysical data product may be transmitted onshore, and/or the tangible and/or non-transitory computer-readable media may be brought onshore. In some instances, once onshore in the United States, geophysical analysis, including further data processing, may be performed on the geophysical data product. In some instances, geophysical analysis may be performed on the geophysical data product offshore. For example, FWI methods may be utilized with long-offset data to create and/or improve velocity models.

In an embodiment, a method includes operating a single source vessel along a survey path in a survey area, the source vessel towing a source and a first plurality of streamers; operating a streamer vessel along the survey path in the survey area, the streamer vessel towing a second plurality of streamers; actuating the source; acquiring, in response to the actuation of the source, near-offset data with a first plurality of receivers on the first plurality of streamers; and acquiring, in response to the actuation of the source, long-offset data with a second plurality of receivers on the second plurality of streamers.

In one or more embodiments disclosed herein, a streamer spacing density of the second plurality of streamers is no greater than a streamer spacing density of the first plurality of streamers.

In one or more embodiments disclosed herein, a streamer separation of the second plurality of streamers is no less than a streamer separation of the first plurality of streamers.

In one or more embodiments disclosed herein, a spread width of the second plurality of streamers is less than a spread width of the first plurality of streamers.

In one or more embodiments disclosed herein, the second plurality of streamers comprises at least two streamers.

In one or more embodiments disclosed herein, the first plurality of streamers comprises at least eight streamers.

In one or more embodiments disclosed herein, the near-offset data comprises high-frequency data.

In one or more embodiments disclosed herein, the long-offset data comprises low-frequency data.

In one or more embodiments disclosed herein, the near-offset data comprises reflection data.

In one or more embodiments disclosed herein, the long-offset data comprises refraction data.

In one or more embodiments disclosed herein, the long-offset data comprises ultra-long-offset data.

In one or more embodiments disclosed herein, an offset between the source and a forward-most receiver of the second plurality of receivers is at least 10 km.

In one or more embodiments disclosed herein, an offset between the source and an aft-most receiver of the second plurality of receivers is at least 20 km.

In one or more embodiments disclosed herein, a method also includes building a velocity model based on the long-offset data.

In one or more embodiments disclosed herein, a method also includes imaging with the velocity model.

In one or more embodiments disclosed herein, a method also includes utilizing a FWI method to build the velocity model.

In one or more embodiments disclosed herein, the long-offset data is indicative of a target in a subsurface formation of the survey area, the target having a formation depth of at least 4 km.

In one or more embodiments disclosed herein, a method also includes utilizing acoustic bracing to determine a position of a streamer of the second plurality of streamers.

In one or more embodiments disclosed herein, the streamer vessel follows the source vessel along the survey path.

In one or more embodiments disclosed herein, a method also includes operating a second streamer vessel along the survey path in the survey area, the second streamer vessel towing a third plurality of streamers; acquiring, in response to the actuation of the source, additional long-offset data with a third plurality of receivers on the third plurality of streamers.

In one or more embodiments disclosed herein, both the source vessel and the second streamer vessel follow the streamer vessel along the survey path.

In one or more embodiments disclosed herein, the survey path comprises multiple sail lines, and a CMP brush along a first sail line overlaps with a CMP brush along a second sail line, the second sail line being adjacent to the first sail line.

In an embodiment, a system includes a source vessel coupled to: a source; and a near-offset survey spread; a streamer vessel coupled to a long-offset survey spread, wherein a streamer spacing density of the long-offset survey spread is no greater than a streamer spacing density of the near-offset survey spread; and a survey plan including navigation information for the source vessel and the streamer vessel, wherein the navigation information directs the source vessel and the streamer vessel along a common survey path while the source is actuated.

In one or more embodiments disclosed herein, the near-offset survey spread is configured to acquire high-frequency data, and the long-offset survey spread is configured to acquire low-frequency data.

In one or more embodiments disclosed herein, the near-offset survey spread is configured to acquire near-offset data.

In one or more embodiments disclosed herein, the long-offset survey spread is configured to acquire long-offset data.

In one or more embodiments disclosed herein, the long-offset survey spread is configured to acquire ultra-long-offset data.

In one or more embodiments disclosed herein, the long-offset survey spread comprises a plurality of streamers and an acoustic bracing network.

In one or more embodiments disclosed herein, a system also includes a second streamer vessel, wherein the navigation information directs the second streamer vessel along the common survey path while the source is actuated.

In an embodiment, a method of manufacturing a geophysical data product includes obtaining geophysical data for a subterranean formation; and processing the geophysical data to produce a model of the subterranean formation; wherein the geophysical data product comprises: near-offset data acquired with a first plurality of receivers on a first plurality of streamers in response to actuation of a source while the first plurality of streamers are towed with a single source vessel along a survey path, and long-offset data acquired with a second plurality of receivers on a second plurality of streamers in response to the actuation of the source while the second plurality of streamers are towed with a streamer vessel along the survey path, wherein a streamer spacing density of the second plurality of streamers is no greater than a streamer spacing density of the first plurality of streamers.

In one or more embodiments disclosed herein, the near-offset data comprises high-frequency data.

In one or more embodiments disclosed herein, the long-offset data comprises low-frequency data.

In one or more embodiments disclosed herein, the near-offset data comprises reflection data.

In one or more embodiments disclosed herein, the long-offset data comprises refraction data.

In one or more embodiments disclosed herein, the long-offset data comprises ultra-long-offset data.

In one or more embodiments disclosed herein, processing the geophysical data comprises building a velocity model based on the long-offset data.

In one or more embodiments disclosed herein, processing the geophysical data further comprises imaging with the velocity model.

In one or more embodiments disclosed herein, processing the geophysical data further comprises utilizing a FWI method to build the velocity model.

In one or more embodiments disclosed herein, a method also includes recording the model on one or more non-transitory computer-readable media, thereby creating the geophysical data product.

In one or more embodiments disclosed herein, a method also includes performing geophysical analysis onshore on the geophysical data product.

While the foregoing is directed to embodiments of the present disclosure, other and further embodiments of the disclosure may be devised without departing from the basic scope thereof, and the scope thereof is determined by the claims that follow.

1. A method, comprising:
operating a single source vessel along a survey path in a survey area, the source vessel towing a source and a first plurality of streamers;
operating a streamer vessel along the survey path in the survey area, the streamer vessel towing a second plurality of streamers;
actuating the source;
acquiring, in response to the actuation of the source, near-offset data with a first plurality of receivers on the first plurality of streamers; and
acquiring, in response to the actuation of the source, long-offset data with a second plurality of receivers on the second plurality of streamers.

2. The method of claim 1, wherein a streamer spacing density of the second plurality of streamers is no greater than a streamer spacing density of the first plurality of streamers.

3. The method of claim 1, wherein the near-offset data comprises high-frequency data, and the long-offset data comprises low-frequency data.

4. The method of claim 1, wherein the near-offset data comprises reflection data, and the long-offset data comprises refraction data.

5. The method of claim 1, wherein an offset between the source and an aft-most receiver of the second plurality of receivers is at least 20 km.

6. The method of claim 1, further comprising building a velocity model based on the long-offset data; and imaging with the velocity model.

7. The method of claim 1, wherein the long-offset data is indicative of a target in a subsurface formation of the survey area, the target having a formation depth of at least 4 km.

8. The method of claim 1, further comprising utilizing acoustic bracing to determine a position of a streamer of the second plurality of streamers.

9. The method of claim 1, further comprising:
operating a second streamer vessel along the survey path in the survey area, the second streamer vessel towing a third plurality of streamers;
acquiring, in response to the actuation of the source, additional long-offset data with a third plurality of receivers on the third plurality of streamers.

10. The method of claim 1, wherein the survey path comprises multiple sail lines, and a CMP brush along a first sail line overlaps with a CMP brush along a second sail line, the second sail line being adjacent to the first sail line.

11. A system comprising:
a source vessel coupled to:
a source; and
a near-offset survey spread;
a streamer vessel coupled to a long-offset survey spread, wherein a streamer spacing density of the long-offset survey spread is no greater than a streamer spacing density of the near-offset survey spread; and
a survey plan including navigation information for the source vessel and the streamer vessel, wherein the navigation information directs the source vessel and the streamer vessel along a common survey path while the source is actuated.

12. The system of claim 11, wherein:
the near-offset survey spread is configured to acquire high-frequency data, and
the long-offset survey spread is configured to acquire low-frequency data.

13. The system of claim 11, wherein the long-offset survey spread is configured to acquire ultra-long-offset data.

14. The system of claim 11, wherein the long-offset survey spread comprises a plurality of streamers and an acoustic bracing network.

15. The system of claim 11, further comprising a second streamer vessel, wherein the navigation information directs the second streamer vessel along the common survey path while the source is actuated.

16. A method of manufacturing a geophysical data product, the method comprising:
obtaining geophysical data for a subterranean formation; and
processing the geophysical data to produce a model of the subterranean formation;
wherein the geophysical data product comprises:
near-offset data acquired with a first plurality of receivers in response to actuation of a source while the first plurality of receivers on a first plurality of streamers are towed with a single source vessel along a survey path, and
long-offset data acquired with a second plurality of receivers in response to the actuation of the source while the second plurality of receivers on a second plurality of streamers are towed with a streamer vessel along the survey path, wherein a streamer spacing density of the second plurality of streamers is no greater than a streamer spacing density of the first plurality of streamers.

17. The method of claim 16, wherein the near-offset data comprises high-frequency data, and the long-offset data comprises low-frequency data.

18. The method of claim 16, wherein the near-offset data comprises reflection data, and the long-offset data comprises refraction data.

19. The method of claim 16, wherein processing the geophysical data comprises one or more of:
building a velocity model based on the long-offset data;
imaging with the velocity model; and
utilizing a FWI method to build the velocity model.

20. The method of claim 16, further comprising recording the model on one or more non-transitory computer-readable media, thereby creating the geophysical data product.
